(19) United States
(12) Patent Application Publication
(10) Pub. No.: US 2009/0083962 A1
(43) Pub. Date: Apr. 2, 2009

(54) FLANGE-FORMING SYSTEM FOR TUBE AND RELATED METHODS

(75) Inventors: Joseph P. Sandman, Morrow, OH (US); Michael N. Sandman, Morrow, OH (US)

Correspondence Address: WOOD, HERRON & EVANS, LLP, 2700 CAREW TOWER, 441 VINE STREET, CINCINNATI, OH, 45202, US

(73) Assignee: LANGDON INCORPORATED, Cincinnati, OH (US)

(21) Appl. No.: 12/270,172

(22) Filed: Nov. 13, 2008

Related U.S. Application Data
(63) Continuation-in-part of application No. 12/167,310, filed on Jul. 3, 2008.
Application No. 12/167,310 is a continuation-in-part of application No. 11/862,472, filed on Sep. 27, 2007.

(51) Int. Cl. B23P 11/00; F16L 13/14; F24F 13/06

(52) U.S. Cl. 29/509; 285/382.5; 454/306

(57) ABSTRACT

In one embodiment, a system is provided for forming a flange at an end of a tube. The system includes a collar that is configured to surround the tube, and a first roller engaging the collar. A second roller is configured to cooperate with the first roller to rotate the collar and the tube and includes a depression configured to receive a radially inwardly protruding portion of the tube therein. A rotatable cam cooperates with the second roller and includes a cam surface configured to bend the end of the tube to thereby form the flange. The depression may be configured to restrict axial movement of the tube relative to the collar. The depression may include an annular recess that is circumferentially disposed about the second roller.

This application is a continuation-in-part of U.S. Ser. No. 12/167,310 filed Jul. 3, 2008, which is a continuation-in-part of U.S. Ser. No. 11/862,472, filed Sep. 27, 2007, the disclosures of which are hereby incorporated herein by reference in their entireties.

### FIELD OF THE INVENTION

The present invention relates generally to devices for forming tubes and, more particularly, to devices for forming a flange at an end of a metal tube such as ductwork.

### BACKGROUND OF THE INVENTION

Metal tubes are used in different applications. For example, hollow tubes are used in heating, ventilation, air conditioning or dust collection systems, such that processed air (e.g., heated, cooled, or return air) or particle-carrying air streams can be directed through an interior of the ducts to different locations within a building.

For example, ventilation ductwork may include two or more ducts connected in series, such as to facilitate distribution and/or directing of air. To this end, the ducts may be manufactured to include a flange at one or both of the ends of the ducts. Confronting flanges from two ducts are then fastened together to secure a connection between the ducts.

Formation of a flange at an end of a duct is often done after the duct has been formed and may require complex equipment and/or processes to form the flange. It may, for example, require complex hydraulic systems which may require high degrees of maintenance.

Conventional processes for forming a flange may include manually hammering an end of the tube against an anvil to thereby form the flange. Other conventional processes include manually supporting and tilting the tube against rotating rollers. The manual nature of these known processes may be unreliable and/or complex, and may result in flanges of inconsistent quality.

In the case of spiral tubes, an added challenge arises from the presence of a seam formed in the wall of the spiral tubes. The seam interferes with conventional processes to thereby produce a distorted flange or one of inconsistent quality.

Consequently, there is a need for a device and related methods for forming a flange at an end of a tube in a consistent manner and which addresses these and other drawbacks.

### SUMMARY OF THE INVENTION

The various embodiments of this invention offer advantages over known systems and processes for forming a flange at an end of a tube.

In one embodiment, a system is provided for forming a flange at an end of a tube. The system includes a collar that is configured to surround the tube, and a first roller engaging the collar. A second roller is configured to cooperate with the first roller to rotate the collar and the tube and includes a depression configured to receive a radially inwardly protruding portion of the tube therein. A rotatable cam cooperates with the second roller and includes a cam surface configured to bend the end of the tube to thereby form the flange. The depression may be configured to restrict axial movement of the tube relative to the collar. The depression may include an annular recess that is circumferentially disposed about the second roller. The depression may, for example, have a generally rounded cross-sectional profile that is configured to receive a complimentarily shaped protruding portion of the tube therein.

The second roller may include an abutment surface in confronting relation with the rotatable cam for limiting axial displacement of the rotatable cam relative to the tube. The system may include a third roller that is selectively engageable with the second roller and which includes a radially outwardly extending protrusion that is engageable with the depression for forming the radially inwardly protruding portion of the tube. The radially outwardly extending protrusion of the third roller may comprise a ring circumferentially disposed about the third roller.

In another embodiment, a system is provided for forming a flange at an end of a tube. The system includes a collar that is configured to surround the tube, and a first roller that engages the collar. A second roller is configured to cooperate with the first roller to rotate the collar and the tube and includes an annular recess configured to receive a radially inwardly protruding portion of the tube therein. A rotatable cam cooperates with the second roller and includes a cam surface configured to bend the end of the tube to thereby form the flange. A third roller is selectively engageable with the second roller and includes a radially outwardly extending protrusion engageable with the annular recess for forming the radially inwardly protruding portion of the tube.

In another embodiment, a method is provided for forming a flange at an end of a tube. The method includes engaging an outer surface of the tube to thereby rotate the tube. A first cam is rotated to advance a cam surface thereof against the end of the tube to thereby form the flange. A radially inwardly protruding portion is formed in the tube generally adjacent the flange. The method may include engaging the radially inwardly protruding portion to restrict movement of the tube relative to the first cam. The method may include positively limiting axial displacement of the first cam relative to the tube. The method may alternatively or additionally include bending a distal edge of the tube into a generally U-shaped profile. The method may include engaging the tube between two complimentarily-shaped structures to thereby form the annular depression. The tube may be engaged between a convex apparatus and a concave apparatus to thereby form the radially inwardly protruding portion. The annular depression may be formed prior to forming the flange. The method may include bending the distal edge of the tube prior to forming the flange.

In yet another embodiment, a method is provided for forming a flange at an end of a tube. The method includes bending a first portion of the tube in a first direction to thereby form a first segment of the flange. A second portion of the tube is bent relative to the first portion in a second direction to thereby form a second segment of the flange. A third portion of the tube is bent relative to the second portion in a third direction, to thereby form a third segment of the flange. The second and third directions may be generally parallel to one another. The first and second directions may be transverse to one another. The first and second directions may, for example, be generally orthogonal to one another. Bending the third portion relative to the second portion may define an outermost edge of the flange. The third portion may be bent relative to the second portion prior to bending of the second portion relative to the first portion.

In another embodiment, an air duct includes a tubular body portion having an end and a flange extending outwardly from the first tubular body portion at that end. The tubular portion includes an annular recess for retaining a gasket therein.

In yet another embodiment, an air duct assembly includes first and second tubular structures. The second tubular structure is coupled to the first tubular structure and has a first flange at an end thereof in confronting relationship with the first tubular structure and an annular recess adjacent the flange. A gasket member is retained in the annular recess and is disposed between the first and second tubular structures for restricting the travel of fluid into an interior portion of the second tubular structure.

### BRIEF DESCRIPTION OF THE DRAWINGS

The objectives and features of the invention will become more readily apparent from the following detailed description taken in conjunction with the accompanying drawings in which:

FIG. 1 is a perspective view of a flange-forming system according to one embodiment of the present invention;

FIG. 2 is a perspective view of a pair of rollers and a rotatable cam of the system of FIG. 1;

FIG. 3 is an elevational view of a groove of a collar of the system of FIG. 1, showing a portion of a seam of a tube therein;

FIG. 4 is a perspective view of a collar and tube of FIG. 1, illustrating the collar disassembled from the tube;

FIG. 4A is a perspective view of a flange-forming system including an alternative collar in accordance with another embodiment of the present invention;

FIG. 5 is an elevational, partial cross-sectional view of a flange-forming system according to another embodiment of the present invention;

FIG. 6 is an elevational, partial cross-sectional view of a flange-forming system according to another embodiment of the present invention;

FIG. 7 is an elevational view of a flange-forming system according to another embodiment of the present invention;

FIG. 8 is a perspective view of a rotatable cam in accordance with the principles of the present invention;

FIG. 9 is a planar view of the rotatable cam of FIG. 8;

FIG. 10 is a perspective view of a rotatable cam in accordance with the principles of the present invention;

FIG. 11 is a planar view of the rotatable cam of FIG. 10;

FIGS. 12A-12Q are cross-sectional views of different embodiments of juncture assemblies according to the principles of the present invention;

FIG. 13 is an elevational, partial cross-sectional view of a flange-forming system according to another embodiment of the present invention;

FIG. 14 is an elevational, partial cross-sectional view of a flange-forming system according to another embodiment of the present invention;

FIG. 15 is partially broken away perspective view of a sheet of metal with a bent portion;

FIG. 16 is an elevational, partial cross-sectional view of a flange-forming system according to another embodiment of the present invention;

FIG. 17 is a partially broken-away perspective view of a tube;

FIG. 18 is a partial schematic view of a tube and flange formed at an end thereof;

FIG. 19 is an elevational view of an air duct assembly;

FIG. 20 is a partially broken away elevational view of another embodiment of an air duct assembly;

FIGS. 21A-21B are partially broken away elevational views of a different embodiment of an air duct assembly;

FIGS. 22A-22B are partially broken away elevational views of a different embodiment of an air duct assembly;

FIGS. 23A-23B are partially broken away elevational views of a different embodiment of an air duct assembly; and

FIG. 24 is a partially broken away elevational view of yet another embodiment of an air duct assembly.

### DETAILED DESCRIPTION OF THE INVENTION

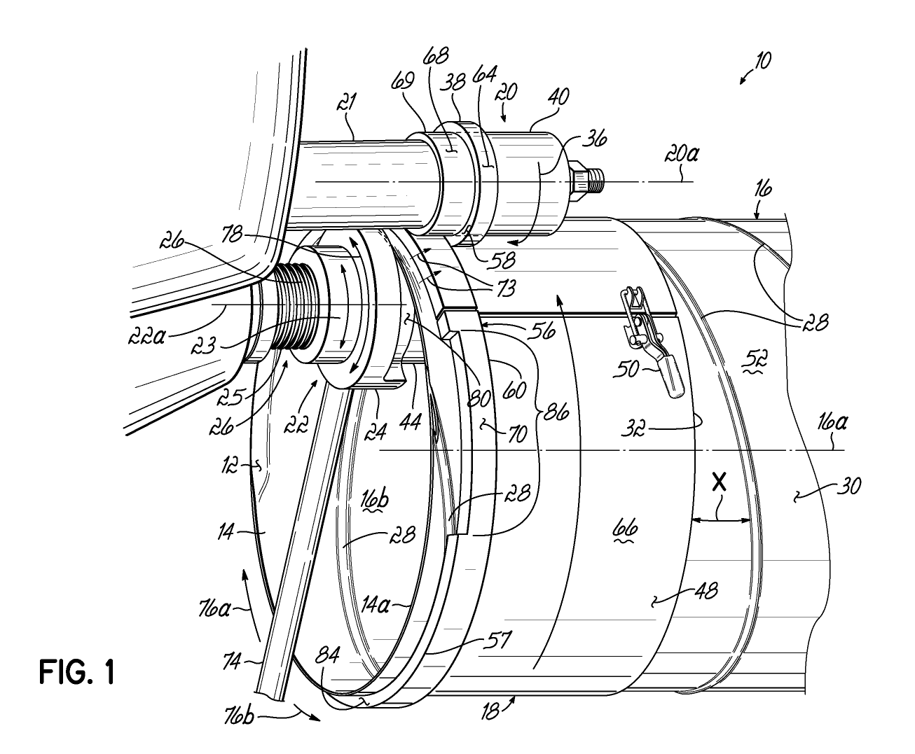

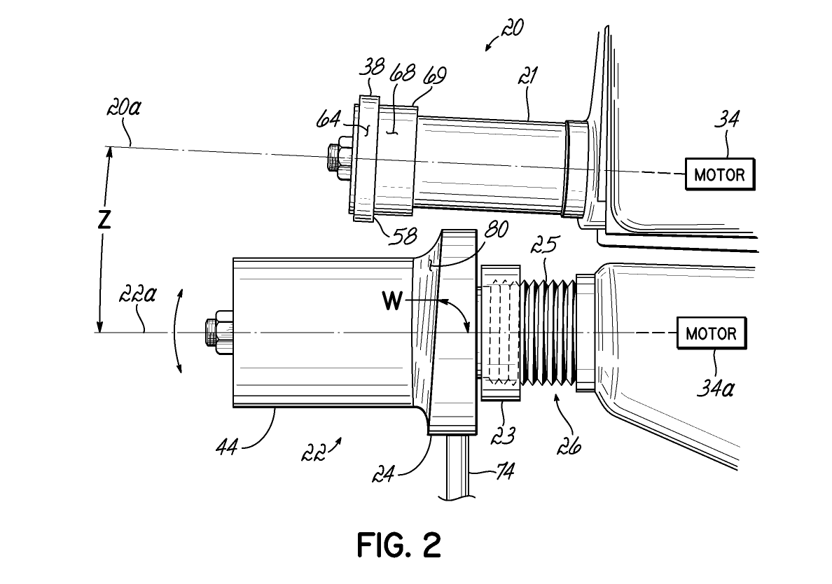

With reference to the figures and, more particularly to FIGS. 1-2, a system 10 is shown for forming a flange 12 at an end 14 of a tube 16, such as a ventilation duct, by way of example, formed from a sheet of metal. The system 10 includes a collar 18 that engages the tube 16, as well as a pair of rollers 20, 22, and a rotatable cam 24. The collar 18 cooperates with the rollers 20, 22, as explained in further detail below, to enable formation of the flange 12. More specifically, the rollers 20, 22 and collar 18 cooperate with one another to restrict and rotate the tube 16 such the rotatable cam 24 can engage end 14 to thereby form the flange 12.

In the exemplary embodiment of FIG. 1, the tube 16 is shown having a helically-directed seam 28 extending on a wall 30 of the tube 16, although other types of tubes are contemplated. In the view depicted in FIG. 1, and when the tube is engaged by the collar 18, the seam 28 defines an acute angle “X” with a first end 32 of the collar 18.

As described above, the system 10 includes a pair of rollers 20, 22. The first roller 20 extends along and rotates about an axis 20a. The first roller may further be driven by a motor 34 operatively coupled to first roller 20 in ways well known to those of ordinary skill in the art. Motor 34, which is diagrammatically depicted in FIG. 2, accordingly rotates the first roller 20, for example, in the direction indicated by arrow 36. The first roller 20 moreover includes a shaft 21 and a lip 38 radially protruding from a main body portion 40 of the lip 38. As explained in further detail below, the lip 38 enables engagement of first roller 20 with collar 18.

With further reference to FIGS. 1-2, the second roller 22 includes a shaft 26 and is rotatable about an axis 22a defined by second roller 22. Accordingly, the second roller 22 may be rotatable, for example, clockwise, counter-clockwise, or both, as indicated by double-headed arrow 23. In one aspect of this embodiment, the second roller 22 is rotatable at least in a direction opposite that of first roller 20, as explained below, to enable rotation of the collar 18 and tube 16.

When the first and second rollers 20, 22 engage the collar 18, the first and second rollers 20, 22 may further be approximately parallel to one another, as shown in FIG. 1. More specifically, orientation of the axes 20a, 22a may define a relatively small angle between them when rollers 20, 22 engage the collar 18. In order to receive the collar 18 between rollers 20, 22, the first roller 20 is movable to an open position relative to the second roller 22 (FIG. 2) where an acute angle “Z” is defined between axes 20a, 22a. Alternatively, the second roller 22 may be movable relative to a fixed first roller 20 or both rollers 20, 22 may be movable relative to one another.

With further reference to FIGS. 1-2, when the first and second rollers 20, 22 engage the collar 18, the second roller 22 supports the tube 16 being held by the collar 18. More particularly, a distal portion 44 of the shaft 26 contacts an interior surface 16b of the tube 16, thereby supporting at least a portion of the tube 16 thereon.

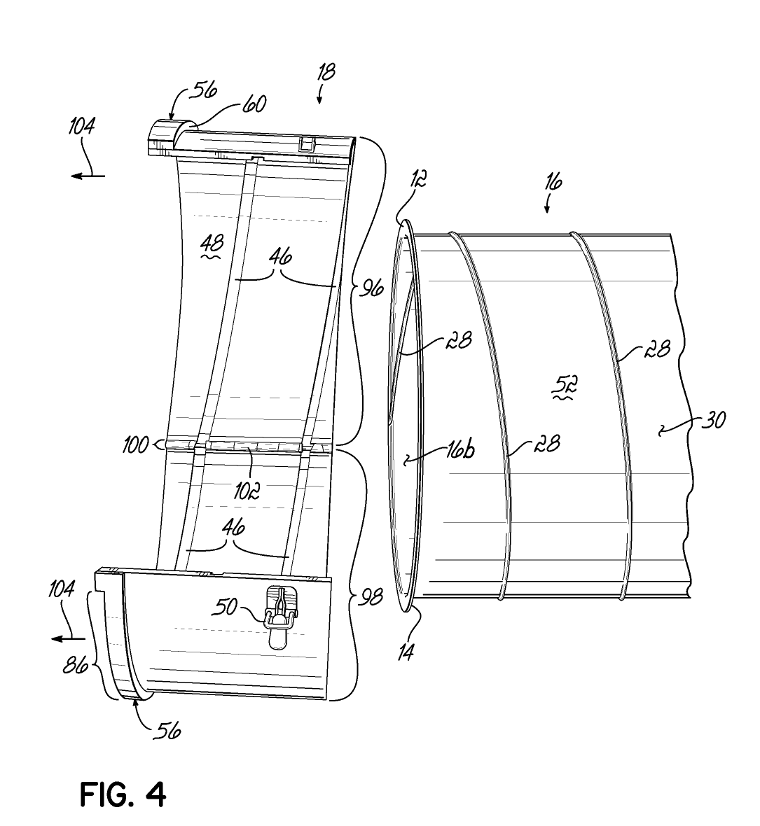

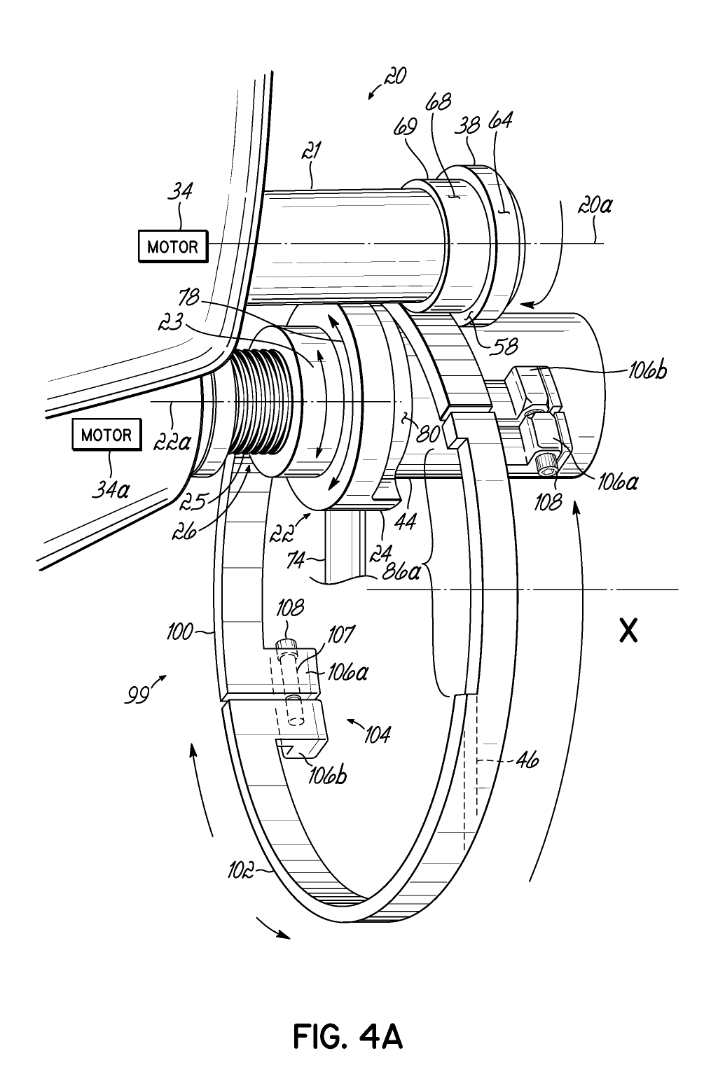

The configurations of the first roller 20 and collar 18 facilitate locking engagement and restriction tube 16 from relative movement, to enable forming of the flange 12. More particularly, the collar 18 lockingly engages the tube 16 to at least restrict rotational and axial movement (i.e., respectively about and along axis 16a) of the tube 16 relative to the collar 18. To this end, collar 18 substantially conforms to an outer surface 52 of the tube 16 and further includes a clamp 50 that lockingly engages the collar 18 against outer surface 52. More specifically, collar 18 includes a channel 46 (FIG. 4) disposed on an inner surface of a wall 48 defining the collar 18. The channel 46 has a helically-directed shape substantially matching the shape of the seam 28 of the tube 16. Accordingly, the channel 46 receives at least a portion of the seam 28 therein to restrict movement of the tube 16 relative to the collar 18. Similarly, the clamp 50 frictionally engages the wall 48 of the collar 18 with the outer surface 52 to further restrict movement of the tube 16 relative to collar 18.

Moreover, first roller 20 restricts the collar 18 from movement relative to the first roller 20, thereby further restricting tube 16 from relative movement. More particularly, a lip 56 positioned at a second end 57 of the collar 18 cooperates with the lip 38 of the first roller 20 to restrict movement of the collar 18. Specifically, as shown in FIG. 1, an end face 58 of the first roller 20 engages an oppositely oriented end face 60 of the lip 56, such that relative movement of the collar 18 and tube 16 is restricted as described above. Accordingly, the axial position (along axis 16a) of end 14 of tube 16 is relatively fixed, which facilitates forming of the flange 12 as explained in more detail below.

FIGS. 1-4 best describe the operation of system 10 in the formation of the flange 12. The system 10 rotates the tube 16 generally about the axis 16a thereof to facilitate forming of the flange by engagement of rotatable cam 24. Rotation of tube 16 is facilitated by engagement of first roller 20 with confronting portions of the collar 18. More particularly, lip 38 of first roller 20 includes a circumferentially directed surface 64 that contacts and frictionally engages an outer surface 66 of the wall 48 of collar 1 8. Rotation of first roller 20 rotates the collar 18, which, in turn, rotates tube 16. Moreover, a circumferentially directed surface 68 of a proximal portion 69 of first roller 20 may cooperate with surface 64 to further facilitate rotation of collar 18. More particularly, the surface 68 may contact and frictionally engage, for example, a rim surface 70 of the lip 56 to facilitate such rotation.

Second roller 22 cooperates with first roller 20 to rotate collar 18 and tube 16. As described above, the distal portion 44 of second roller 22 supports the tube 16 by contacting the interior surface 16b of the tube 16. When the first and second rollers 20, 22 engage the collar 18 (as shown in FIG. 1), the lip 38 and distal portion 44 cooperatively nip the collar 18 and tube 16. The resulting nipped engagement facilitates rotation of the tube 16 and collar 18 as rollers 20, 22 rotate. To this end, the second roller 22 may be suitably motorized, via motor 34a (FIG. 2), such that rotation of the distal portion 44 effectively matches (though in opposite directions) a surface speed of the lip 38. Alternatively, the second roller 22 may be made to follow the surface speed of the interior surface 16b, which is induced by motorized rotation of first roller 20.

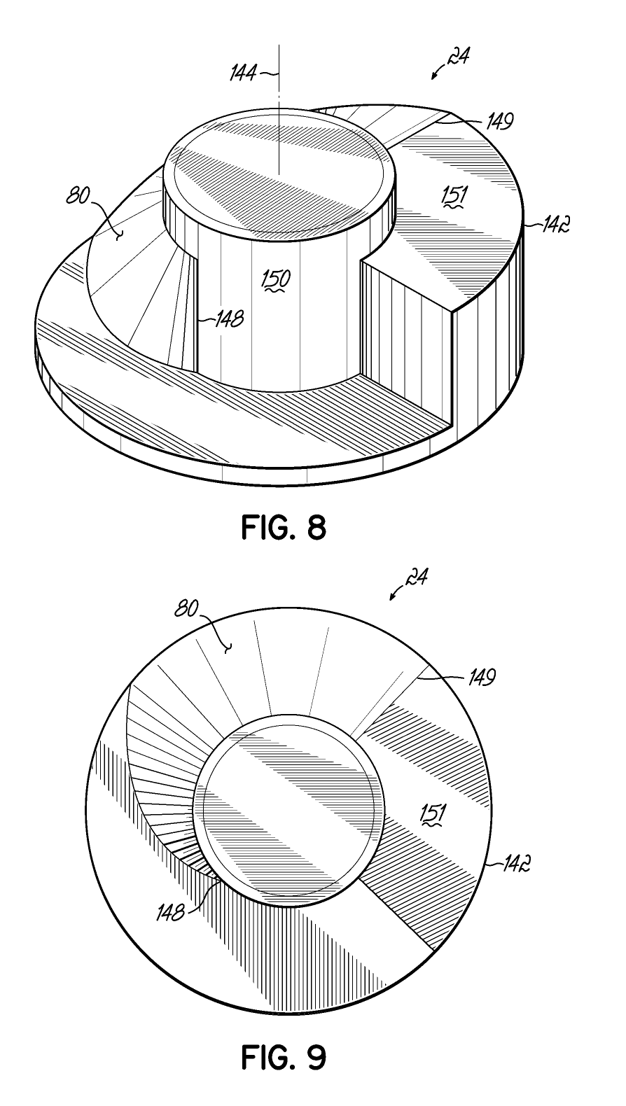

With further reference to FIGS. 1-4, rotation of the tube 16 enables formation of the flange 12 by engagement of the rotatable cam 24 with end 14 of tube 16. More particularly, such engagement bends the end 14 in a direction generally indicated by arrows 73 (FIG. 1). Rotatable cam 24 is disposed about and cooperates with the second roller 22 and is rotatable, about axis 22a, relative to second roller 22. Moreover, the position of rotatable cam 24 along axis 22a is determined by the position of an adjustment collar 23 threadably engaged with a threaded portion 25 of second roller 22. In this regard, adjustment collar 23 prevents movement of the rotatable cam 24 away from the tube 16. Rotation of rotatable cam 24 advances a cam surface 80 of rotatable cam 24 against end 14 to form flange 12. To this end, cam surface 80 extends circumferentially about axis 22a of second roller 22 and is oriented on a plane defining an acute angle “W” relative to axis 22a. The rotatable cam is explained in further detail below, with reference to FIGS. 8-11.

In one aspect of the embodiment depicted in FIGS. 1-4, the length (i.e., radial dimension) of the resulting flange 12 is determined by a position of an end face 84, at second end 57 of collar 18, relative to an end edge 14a of tube 16. More specifically, the end face 84 provides a limiting surface against which cam surface 80 is restricted from advancing along axis 22a when rotatable cam 24 is rotated. Accordingly, a user may be able to control the length of the resulting flange 12 by choosing the length of tube 16 that extends beyond the second end 57.

Rotation of rotatable cam 24 is facilitated by suitably chosen components. In this exemplary embodiment, and by way of example, rotatable cam 24 is manually rotatable by suitable motion of a handle 74 coupled to rotatable cam 24. Handle 74 is in the form of a generally elongate element oriented transverse to the axis 22a. Accordingly, rotation of handle 74 in the general directions of arrows 76a, 76b cause a corresponding rotation of rotatable cam 24 in the general direction of arrow 78, which engages tube 16 to form flange 12. Those of ordinary skill in the art will readily appreciate other types of handles or the like that can be alternatively used to rotate rotatable cam 24. Moreover, rotatable cam 24 may alternatively be motorized or otherwise have other non-manual types of actuation.

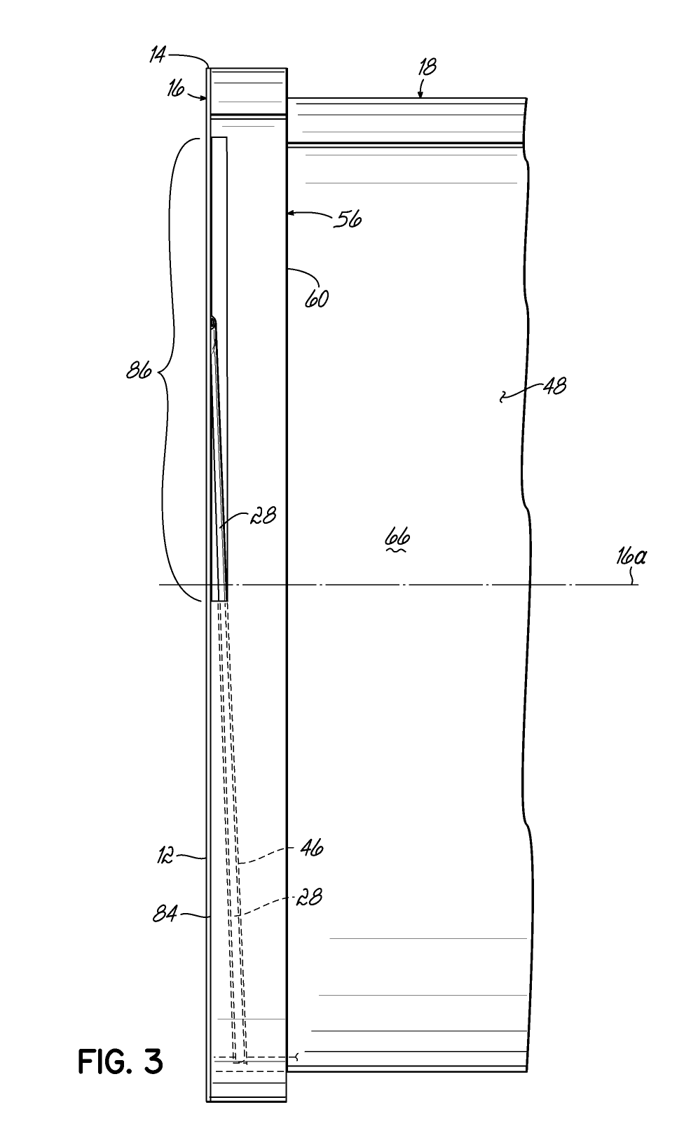

With particular reference to FIG. 3, collar 18 is configured to facilitate formation of flange 12 in the presence of seam 28. More particularly, lip 56 of collar 18 includes a groove 86 that extends along a portion of the lip 56. The groove 86 is configured to receive the seam 28 as the flange 12 is being formed. As the end 14 of tube 16 is bent in the direction indicated by arrows 73 (FIG. 1), the portion of seam 28 that protrudes beyond the end face 84 is received within the groove 86. To this end, the length (the circumferential dimension along lip 56) and depth (i.e., the direction along axis 16a) of the groove 86 are suitably chosen to accommodate the portion of seam 28 extending beyond end face 84.

With particular reference to FIG. 4, the collar 18 may be disengaged and separated from tube 16 (in the general direction of arrow 104) after formation of the flange 12. To this end, the collar 18 includes two shells 96, 98 coupled along a juncture 100 that facilitate engagement and disengagement of collar 18 from tube 16. Coupling between shells 96, 98 is suitably chosen and may include conventional hinges 102 of types well known in the art. Engagement and disengagement are further facilitated by clamp 50, which selectively moves the two shells 96, 98 into locking engagement with outer surface 52 of the tube 16.

Those of ordinary skill in the art will readily appreciate that other types of collars may be used in combination with the other components of the system 10 herein described. For example, and without limitation, an alternative collar may have more than two shells or even include a single shell, so long as the collar includes features to restrict movement of the tube 16 relative to the collar. Similarly, a collar may take on a different form. For example, and with reference to the embodiment of FIG. 4A, an alternative embodiment of a flange-forming system includes a collar 99 that is different from the collar 18 of the embodiment of FIGS. 1-4. For ease of understanding, like reference numerals in FIG. 4A refer to like features in FIGS. 1-4. Collar 99 is similar in structure and function to lip 56 of collar 18, including, for example, a groove 86a, having a function similar to that of groove 86 of FIG. 1. In this regard, the description of lip portion 56 may be referred-to for an understanding of collar 99 as well.

With continued reference to FIG. 4A, collar 99 is defined by two lip halves 100, 102 that are joined via diametrically opposed clamps 104. Each clamp 104 includes a pair of opposed blocks 106a, 106b extending from lip halves 100, 102. A threaded bore 107 extends through each block 106a, 106b and is configured to receive a bolt 108 or similar connector to thereby secure each pair of confronting blocks 106a, 106b against one another. When the two lip halves 100, 102 are wrapped about an end portion of a tube 16 (not shown) and the two pairs of blocks 106a, 106b are fastened via bolts 108, the collar 99 lockingly engages the tube 16.

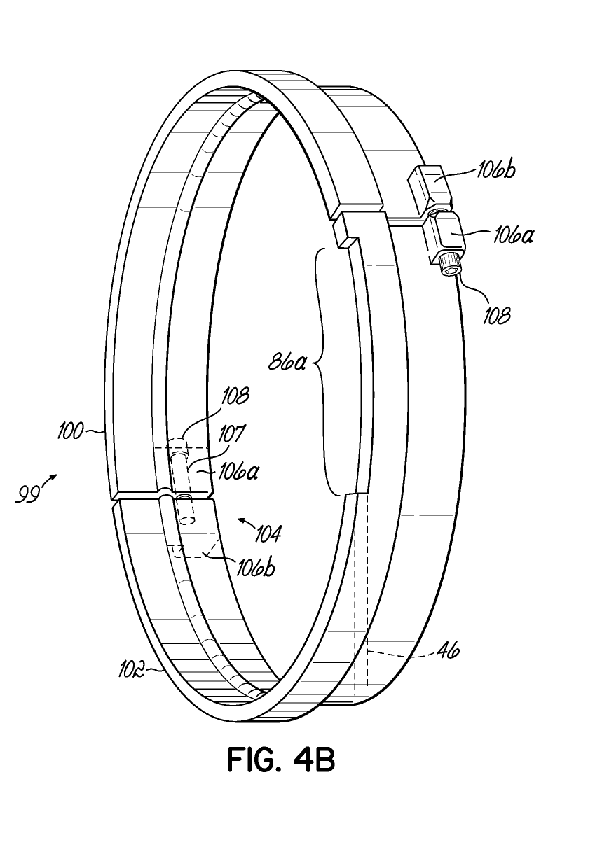

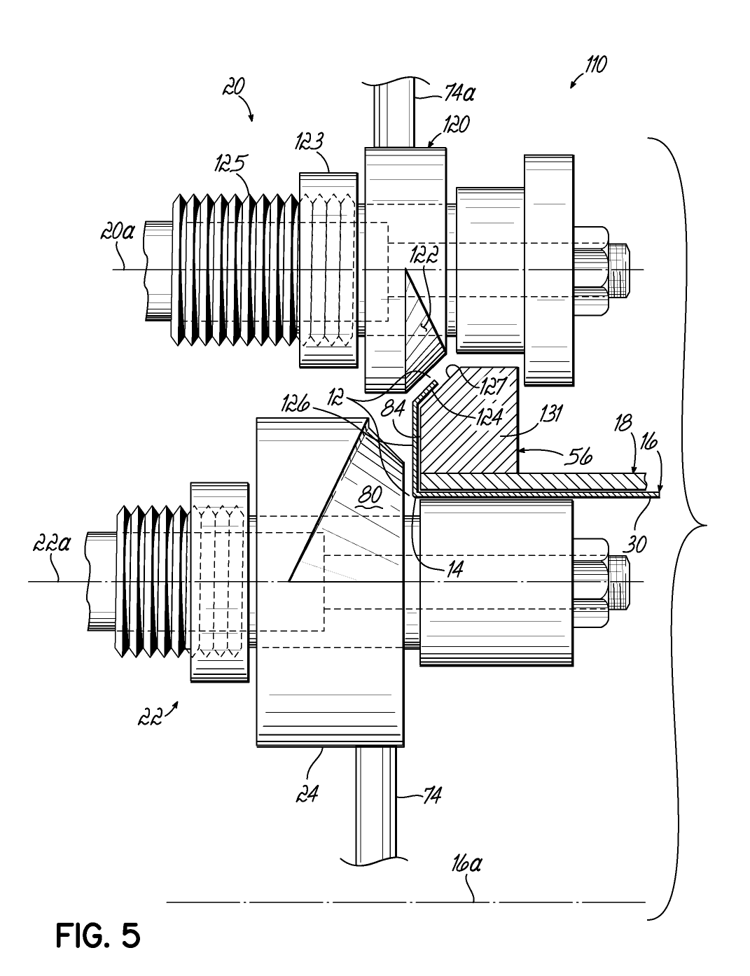

With reference to FIG. 5, in which like reference numerals refer to like features of FIGS. 1-4, another embodiment of a system 110 is configured for forming a flange 12 at an end 14 of a tube 16. System 110 includes components similar in most respects to those of system 10 (FIGS. 1-4), the description of which may be referred to for an understanding of system 110 as well.

System 110 includes a second rotatable cam 120 disposed about first roller 20 and rotatable about axis 20a of the first roller 20. The position of second rotatable cam 120 along axis 22a is determined by the position of a second adjustment collar 123 threadably engaged with a threaded portion 125 of first roller 20. In this regard, second adjustment collar 123 prevents movement of the second rotatable cam 120 away from the tube 16. Moreover, rotation of second rotatable cam 120 is facilitated by a handle 74a projecting therefrom and similar to handle 74. Second rotatable cam 120 includes a second cam surface 122 oriented such that rotation of second rotatable cam 120 advances second cam surface 122 in a direction along axis 20a. More particularly, the second cam surface 122 can be advanced against a distal portion 124 at end 14 of tube 16 to further define the flange 12. In this regard, advancement of second cam surface 122 bends the distal portion 124 in a direction transverse to a first leg or portion 126 of the flange 12. Advancement of the second cam surface 122 to bend distal portion 124 may be limited by a second limiting surface 127 of collar 18.

With further reference to FIG. 5, and by way of example, the second limiting surface 127 may be connected to or be integrally formed with lip 56 of collar 18 (as shown in FIG. 5). Moreover, second limiting surface 127 is oriented such that it defines an acute angle relative to end face 84, thereby permitting formation of a flange 12 having a distal leg or portion 124 oriented at an acute angle relative to first leg or portion 126 of the flange 12. Alternatively, the second limiting surface 127 may be coupled to or be integrally formed with another suitably chosen structure and/or be oriented at any angle relative to end face 84. Alternatively also, system 110 may include no second limiting surface 127 at all.

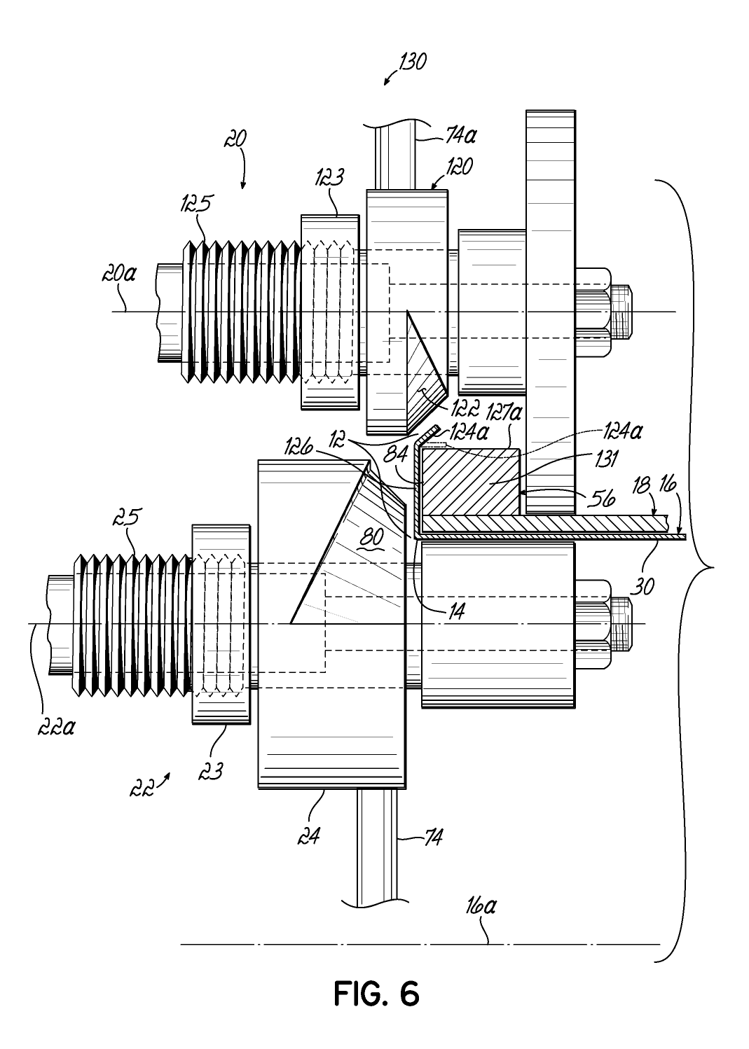

With reference to FIG. 6, in which like reference numerals refer to like features of the embodiment of FIG. 5, another embodiment of a flange-forming system 130 is illustrated, that is similar in most respects to system 110 of FIG. 5. In this regard, the description of system 110 may be referred to for an understanding of system 130 as well. System 130 includes a flange support structure 131 defining a second limiting surface 127a that is oriented generally orthogonal to end face 84 of lip 56. Accordingly, system 130 is capable of forming a flange 12 having first and second legs or portions 126, 124a that are generally orthogonal to one another. In this regard, FIG. 6 shows a first position of second leg portion 124a in solid lines and a subsequent position in phantom.

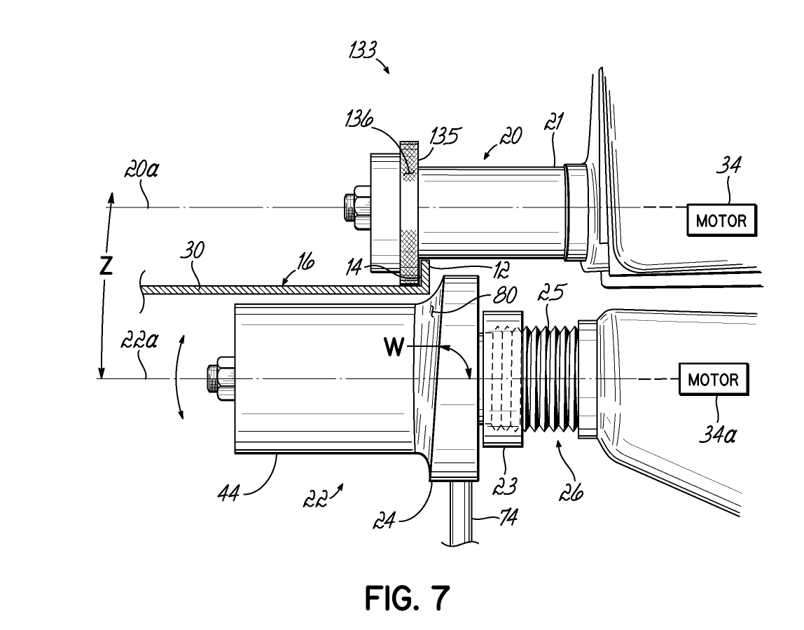

With reference to FIG. 7, in which like reference numerals refer to like features in FIGS. 1-2, another embodiment of a flange-forming system 133 is illustrated, that is similar in most respects to system 10 of FIGS. 1-2, but unlike system 10, includes no collar at all. A wheel 135 is disposed on a first roller 20 of the system and is configured to frictionally drive the tube 16. In this regard, the wheel 135 may have a textured surface 136, as shown, or a surface otherwise configured to frictionally rotate tube 16 by engaging wall 30 thereof. Other aspects of the flange-forming process enabled by system 133 are similar to those of system 10 (FIGS. 1-2), the description of which may be referred to for an understanding of the process enabled by system 133 as well.

With reference to FIGS. 8-11, exemplary configurations of each of the first and second rotatable cams 24, 120 are respectively depicted. With particular reference to FIGS. 8-9, the rotatable cam 24 is a generally cylindrical structure defining an outer circumferential perimeter 142 disposed about a main axis 144. In this regard, the rotatable cam 24 rotates about main axis 144 to cause the cam surface 80 thereof to advance against a tube, as explained above in regards to the embodiment of FIGS. 1-2. Cam surface 80 extends circumferentially about and axially along main axis 144, between a first edge 148 and a second edge 149.

First edge 148 lies generally on a cylindrical surface 150 of the rotatable cam 24, being therefore generally parallel to the main axis 144. By contrast, second edge 149 is oriented substantially orthogonal to the main axis 144, lying on a distal surface 151 of the rotatable cam 24, and is therefore oriented orthogonal to the first edge 148. The cam surface 80, accordingly, gradually and smoothly transitions from a first orientation at first edge 148, to a second orientation at second edge 149. This gradual transition provides for smooth, outward bending of the end portion 14 of tube 16, to thereby form the flange 12 (in the embodiment of FIGS. 1-2) or at least a first leg or portion 126 thereof (in the embodiment of FIG. 5). Cam surface 80 further extends radially to the outer perimeter 142 of the rotatable cam 24. In operation, the radial extension of cam surface 80 defines the length of the flange 12 (FIG. 1) or at least that of the first leg or portion 126 thereof (FIG. 5).

With particular reference to FIGS. 10-11, the rotatable cam 120 is a generally cylindrical structure defining an outer circumferential perimeter 162 disposed about a main axis 164. In this regard, the rotatable cam 120 rotates about main axis 164 to cause cam surface 122 thereof to advance against a tube 16, as explained above in regards to the embodiment of FIGS. 5-6. Cam surface 122 extends circumferentially about and axially along main axis 164, between a first edge 168 and a second edge 169.

First edge 168 lies generally on a plane defined by a base surface 170 of the rotatable cam 120, being therefore generally orthogonal to the main axis 164. By contrast, second edge 169 is oriented generally substantially parallel to the main axis 164 and therefore orthogonal to the first edge 168. The cam surface 122, accordingly, gradually and smoothly transitions from a first orientation at first edge 168, to a second orientation at second edge 169. This gradual transition provides for smooth, outward bending of distal portion 124 of tube 14, to thereby form the second leg or portion 124, 124a of flange 12 (FIGS. 5-6). Cam surface 122 further extends radially to define an inner perimeter 172, lying within the area defined by outer perimeter 162. In this regard, therefore, cam surface 122 does not extend to the outer perimeter 162. In operation, the radial extension of cam surface 122 defines the length of the second leg or portion 124, 124a of formed flange 12.

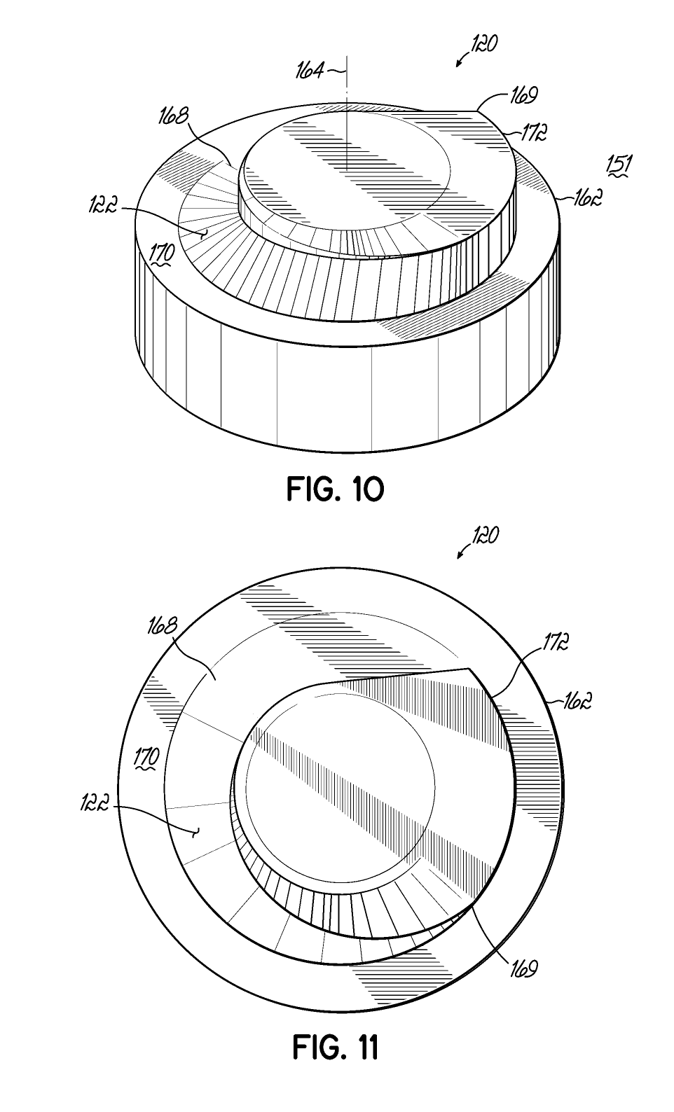

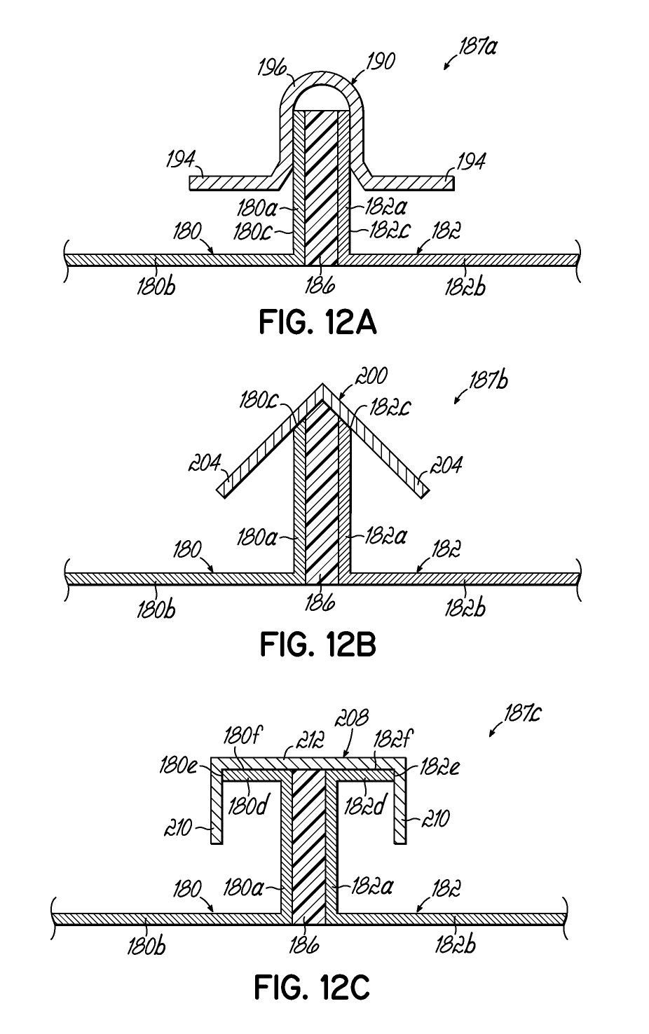

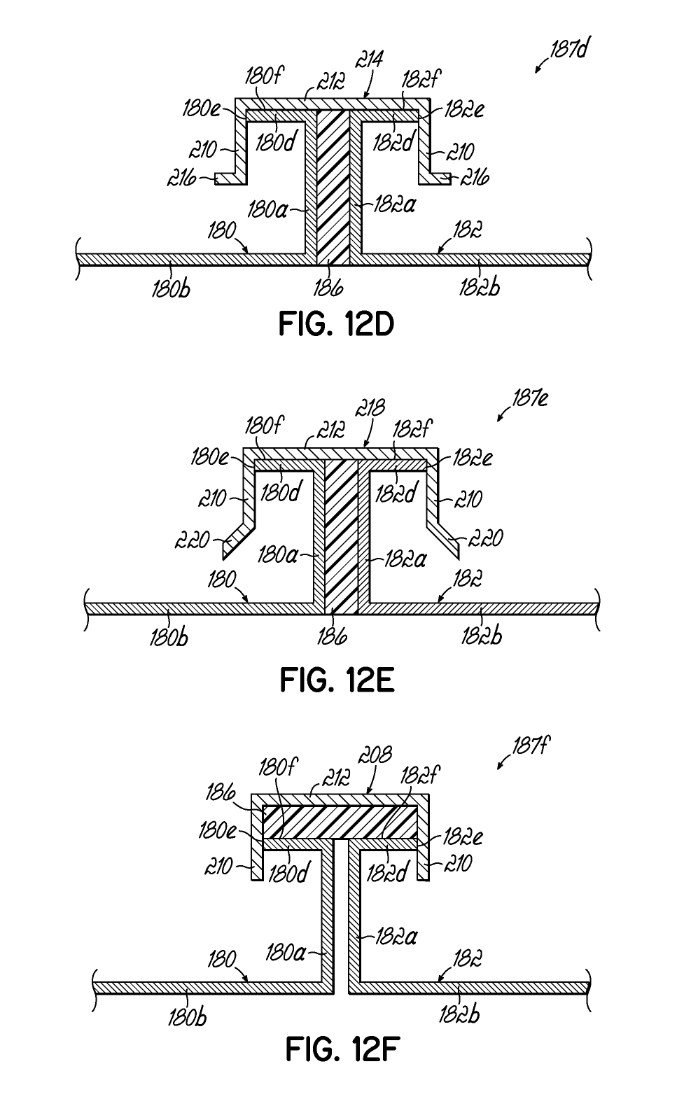

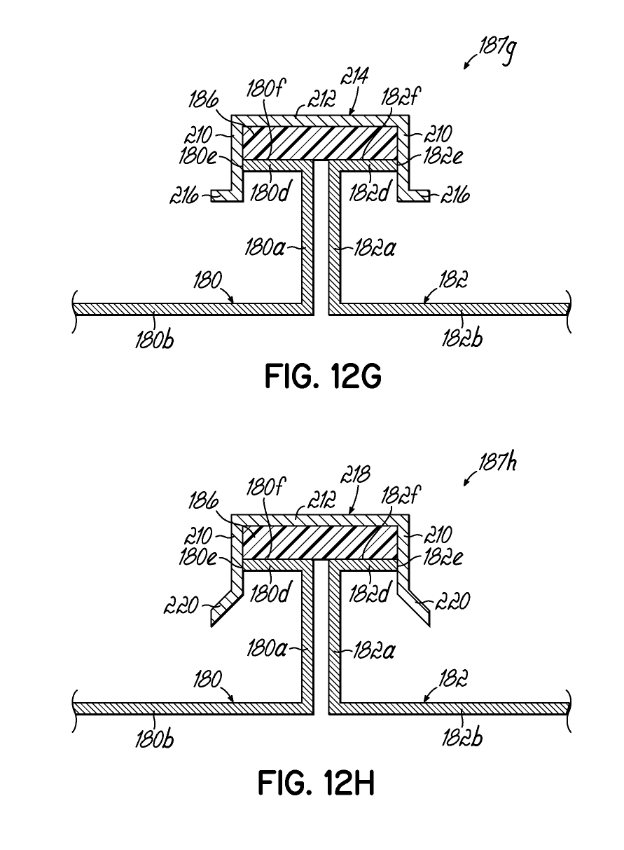

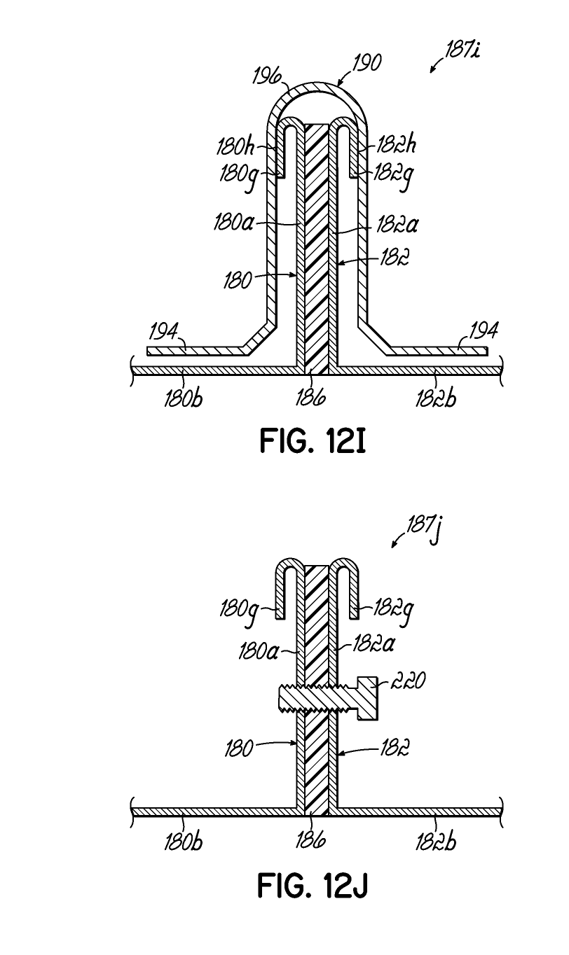

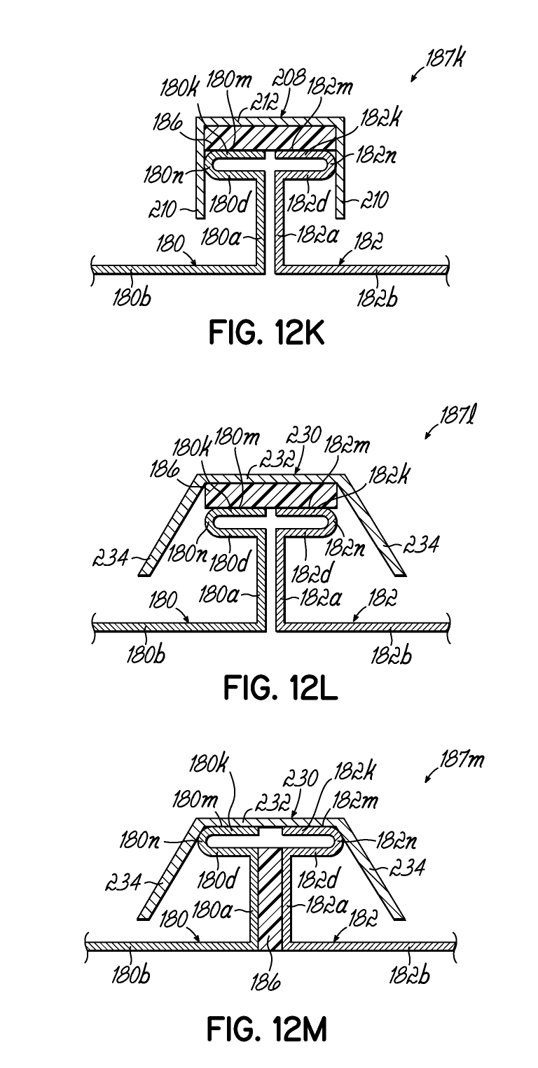

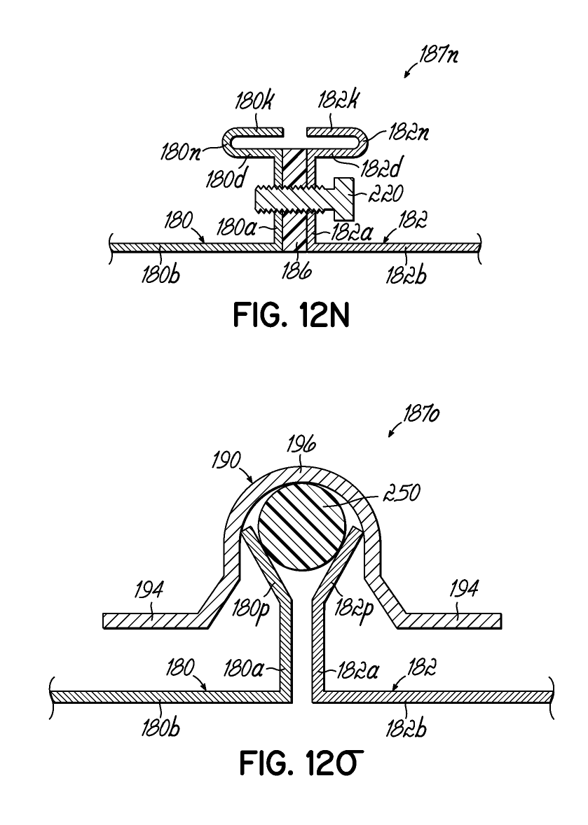

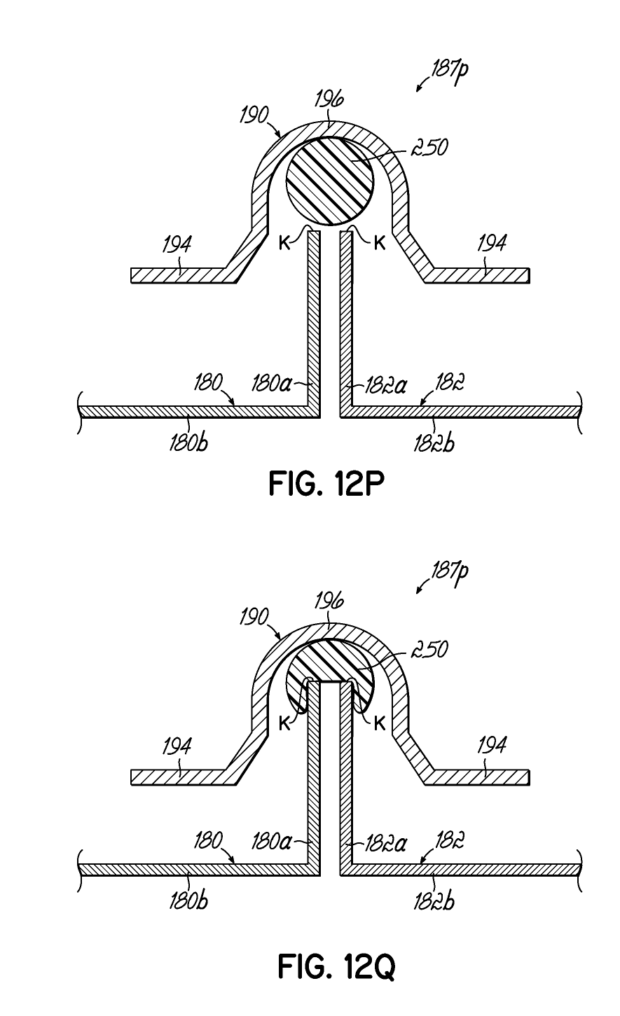

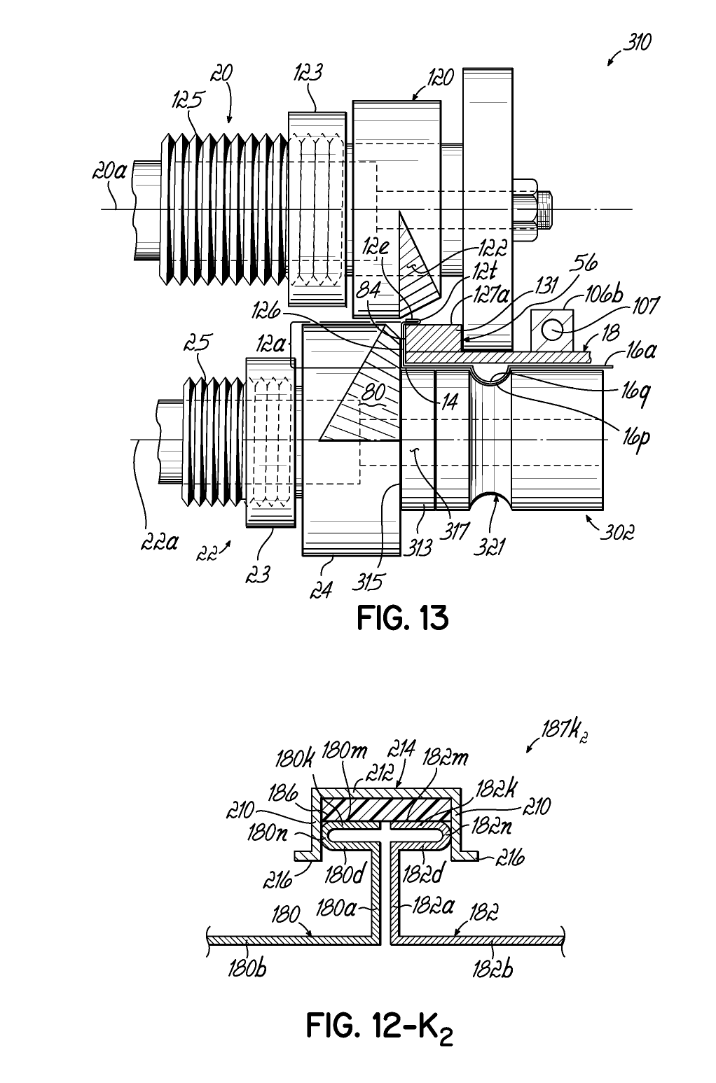

With reference to FIGS. 12A-12Q, different embodiments of flange juncture assemblies are depicted, some of the features of which are facilitated by the systems described above. For ease of understanding, like features in these embodiments have like numerals.

With reference to FIGS. 12A and 12B, first and second flanges 180, 182 are positioned in a confronting relationship such that they may be joined with one another. Each of the first and second flanges 180, 182 is defined by a single leg 180a, 182a extending generally orthogonal to a main tube wall 180b, 182b. The juncture assembly includes a gasket member 186 disposed in a gap defined between legs 180a, 182a. Gasket member 186 has a generally rectangular cross-section, such as, for example and without limitation, rectangular. The cross-sectional shape of the gasket member 186 is suitably chosen such that it includes flat surfaces facing each of the legs 180a, 182a. Accordingly, gasket member 186 is configured to prevent travel of fluids through the gap between legs 180a, 182a. For example, and without limitation, gasket member 186 prevents travel of liquids such as water and gases such as processed air, return air or particle-carrying air streams into and/or out of the ductwork of which the flanges 180, 182 form part.

With particular reference to FIG. 12A, a juncture assembly 187a includes a clamp member 190 disposed over flanges 180, 182, contacting and applying a compressive force against outer surfaces 180c, 182c thereof, to thereby couple flanges 180, 182 to one another. Clamp member 190 is defined by clamp legs 194 extending generally parallel to main tube walls 180b, 182b, and a loop portion 196 formed between and joining clamp legs 194. Clamp member 190, and more particularly loop portion 196 thereof, prevents travel of fluid through the gap between first legs 180a, 182a and through or around gasket member 186.

With particular reference to FIG. 12B, a juncture assembly 187b includes a generally V-shaped clamp member 200 disposed over flanges 180, 182, contacting and applying a compressive force against outer surfaces 180c, 182c thereof, to thereby couple flanges 180, 182 to one another. Clamp member 200 is defined by clamp legs 204 extending so as to define an acute angle relative to main tube walls 180b, 182b. Clamp member 200 prevents travel of fluid through the gap between first legs 180a, 182a and through or around gasket member 186.

With particular reference to FIGS, 12C-12H, each of the embodiments shown therein includes, in addition to first legs 180a, 182a, a pair of second legs 180d, 182d respectively extending from each of the first legs 180a, 182a. In these illustrative embodiments, each of the second legs 180d, 182d is oriented substantially orthogonal to respective first legs 180a, 182a. This is, however, not intended to be limiting, as second legs 180d, 182d may alternatively be oriented to define an acute or obtuse angle relative to first legs 180a, 182a.

With particular reference to FIG. 12C, a juncture assembly 187c includes a generally C-shaped clamp member 208 defined by opposed legs 210 and a center portion 212. Clamp member 208 is disposed over flanges 180, 182, contacting and applying a compressive force against ends 180e, 182e of second legs 180d, 182d, thereby coupling flanges 180, 182 to one another. Clamp member 208 also contacts outermost surfaces 180f, 182f of second legs 180d, 182d. Clamp member 208, and more particularly center portion 212 thereof, prevents travel of fluids through the gap between first legs 180a, 182a and through or around gasket member 186.

With particular reference to FIG. 12D, a juncture assembly 187d is similar to juncture assembly 187c (FIG. 12C) and includes a clamp member 214 similar to clamp member 208 but further including end portions 216 extending from legs 210 and oriented generally parallel to main tube walls 180b, 182b.

With particular reference to FIG. 12E, a juncture assembly 187e is similar to juncture assembly 187d (FIG. 12D) and includes a clamp member 218 similar to clamp member 214 but further including end portions 220 that are oriented such as to define an acute angle relative to main tube walls 180b, 182b.

With particular reference to FIG. 12F, a juncture assembly 187f has components that are similar to those of juncture assembly 187c (FIG. 12C) but where the gasket member 186 is disposed over outermost surfaces 180f, 182f of second legs 180d, 182d. In this regard, accordingly, clamp member 208 contacts only ends 180e, 182e, applying a compressive force against them to thereby couple flanges 180, 182 to one another.

With particular reference to FIG. 12G, a juncture assembly 187g combines aspects of the embodiments of FIGS. 12D and 12F. More particularly, juncture assembly 187g includes the general structure of juncture assembly 187f (FIG. 12F) and the clamp member 214 of juncture assembly 187d (FIG. 12D). Accordingly, the structure and function of juncture assemblies 187d, 187f may be referred to for an understanding of juncture assembly 187g as well.

With particular reference to FIG. 12H, a juncture assembly 187h combines aspects of the embodiments of FIGS. 12E and 12F. More particularly, juncture assembly 187h includes the general structure of juncture assembly 187f (FIG. 12F) and the clamp member 218 of juncture assembly 187e (FIG. 12E). Accordingly, the structure and function of juncture assemblies 187e, 187f may be referred to for an understanding of juncture assembly 187h as well.

With particular reference to FIGS. 12I-12J, each of the embodiments shown therein includes, in addition to first legs 180a, 182a, a pair of second legs 180g, 182g respectively extending from each of the first legs 180a, 182a but oriented so as to define an angle of about 180° relative to each of the first legs 180a, 182a. The junction between each of the first legs 180a, 182a and each of the second legs 180g, 182g is depicted as a loop, although this is not intended to be limiting but rather merely exemplary.

With particular reference to FIG. 12J, a juncture assembly 187j includes a clamp member 190 similar in structure and function to that of FIG. 12A. Clamp member 190 contacts and applies a compressive force against outer surfaces 180h, 182h of second legs 180g, 182g, thereby coupling flanges 180, 182 to one another.

With particular reference to FIG. 12J, a juncture assembly 187j is similar in structure to juncture assembly 187i (FIG. 12I) but includes no clamp member at all. Instead, a connector or fastener, such as a bolt 220 couples flanges 180 and 182 to one another, thereby also mechanically fastening gasket member 186 to first legs 180a, 182a.

With particular reference to FIGS. 12K-12N, each of the embodiments shown therein includes, in addition to first legs 180a, 182a and second legs 180d, 182d, a pair of third legs 180k, 182k respectively extending from each of the second legs 180d, 182d and oriented generally transverse (e.g., orthogonal) to first legs 180a, 182a. The junction between each of the second legs 180d, 182d and each of the third legs 180k, 182k is depicted as a loop 180n, 182n, although this is not intended to be limiting but rather merely illustrative.

With particular reference to FIG. 12K, a juncture assembly 187k includes a gasket member 186 disposed over outer surfaces 180m, 182m of third legs 180k, 182k, as shown. A C-shaped clamp member 208 is disposed over gasket member 186 and applies a compressive force against loops 180n, 182n, thereby coupling flanges 180 and 182 to one another. FIG. 12K₂ shows a juncture assembly 187k₂ similar to juncture assembly 187k but including a clamp member 214 similar to the clamp members 214 of the embodiments of FIGS. 12D and 12G.

With particular reference to FIG. 12L, a juncture assembly 187l is similar to juncture assembly 187k (FIG. 12K) but includes a clamp member 230 having a central portion 232 and two opposed legs 234, each defining an acute angle relative to central portion 232.

With particular reference to FIG. 12M, a juncture assembly 187m combines the clamp member 230 of juncture assembly 1871 (FIG. 12L) with a flange structure including a gasket member 186 placed between the first legs 180a, 182a similarly in this regard, for example, to the embodiment of FIG. 12A.

With particular reference to FIG. 12N, a juncture assembly 187n is similar to juncture assembly 187m (FIG. 12M) but includes no clamp member at all. Instead, a connector or fastener, such as a bolt 220 couples flanges 180 and 182 to one another, thereby also mechanically fastening gasket member 186 to first legs 180a, 182a.

With particular reference to FIG. 12O, a juncture assembly 187o includes, in addition to first legs 180a, 182a, a pair of second legs 180p, 182p respectively extending from each of the first legs 180a, 182a and oriented so as to define an acute angle relative to each of the first legs 180a, 182a. Moreover, an angle between second legs 180p, 182p defines a recess configured to accept a gasket member 250 having a cross-section other than one including flat surfaces (e.g., gasket member 86 of FIGS. 12A-12N). In this exemplary embodiment, for example, gasket member 250 is depicted having a circular cross-section, although this is not intended to be limiting. A clamp member 190 is disposed to contact and apply compressive forces against gasket member 250, as well as second legs 180p, 182p, thereby coupling flanges 180, 182 to one another.

With continued reference to FIG. 120, and similarly to the embodiments of FIGS. 12A-12M, the clamp member 190 and the position of gasket member 250 jointly prevent travel of fluids through the gap between first legs 180a, 182a and through or around gasket member 250.

With particular reference to FIGS. 12P-12Q, a juncture assembly 187p includes a gasket member 250 (similar to the gasket member of FIG. 12O), that is disposed adjacent the ends “k” of the first legs 180a, 182a. As shown in FIG. 12Q, the gasket member 250 is deformable about and conforms to the ends “k” to thereby prevent access, for example, by fluids such as water, to the space between the first legs 180a, 182a. Gasket member 250 deforms, for example, by action of clamp member 190, which thereby secures the gasket member 250 to the first legs 180a, 182a and further secures the flanges 180, 182 to one another.

With reference to FIG. 13, in which like reference numerals refer to like features of FIGS. 1-7, another embodiment of a system 310 for forming a flange 12a at the end of a tube 16a is illustrated. In this regard, the description of the structure, relationship and functions of these like features in the embodiments of FIGS. 1-7 may be referred-to for an understanding of like features of system 310 as well. System 310 includes a second roller 302 having an extension element 313 that provides a stopping, limiting, or abutment surface 315 for limiting axial displacement of the rotatable cam 24 relative to the tube 16a. To this end, abutment surface 315 is generally aligned with end face 84 of collar 18. Moreover, extension element 313 provides a support surface 317 for the tube 16a, as shown in the figure.

The second roller 302 of this exemplary embodiment includes a depression in the form of a radially inwardly extending annular recess 321 that receives a radially inwardly protruding portion of the tube 16a. In this regard, the annular recess 321 of this embodiment has a generally rounded, concave cross-sectional profile that receives a complementarily-shaped radially inwardly annular protruding portion or bead 16p of tube 16a also having a generally rounded cross-sectional profile. Engagement of the annular recess 321 and annular protruding portion 16p with one another further restricts axial movement of the tube 16a relative to the collar 56. This restriction, in turn, maintains the end 14 of the tube 16a at a constant distance from the rotatable cam 24. The protruding portion 16p of the tube 16a defines an opposed annular recess 16q on the outer surface of the tube 16a.

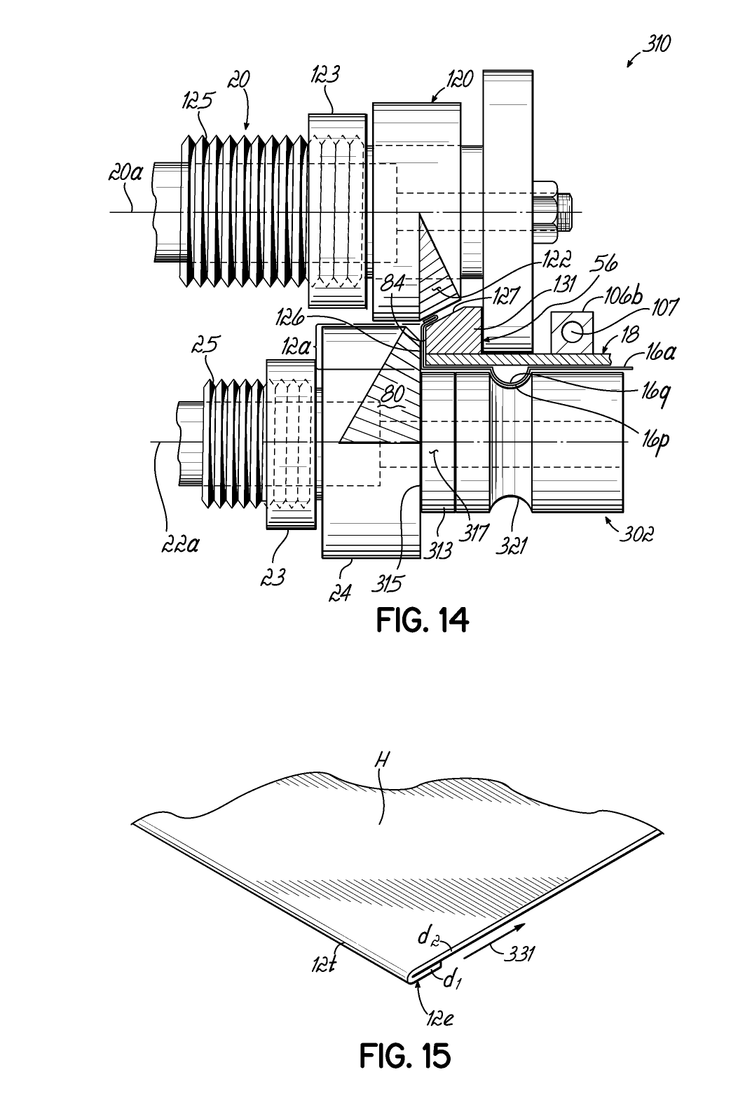

With continued reference to FIG. 13, the formed flange 12a includes a generally U-shaped end 12e defining a relatively smooth outermost edge 12t of the flange 12a and, thus, a relatively smooth outermost edge 12t of the tube 16a. Exemplary methods for forming the end 12e, as well as the annular protruding portion 16p are discussed in further detail below. While the features of the exemplary second roller 302 are described in combination with a generally second stopping or limiting surface 127a as described with respect to the embodiment of FIG. 6, it is contemplated that the same could be alternatively combined with an angled second stopping or limiting surface 127, as described with respect to the embodiment of FIG. 5, as shown, for example, in FIG. 14. Likewise, it is contemplated that system 310 may alternatively have no extension element 313 at all or have a different structure providing support for tube 16a and/or providing an abutment surface for restricting axial movement of rotatable cam 24.

With reference to FIGS. 15, 16, and 17, exemplary methods are illustrated for forming the generally U-shaped end 12e and the annular protruding portion 16p of tube 16a. With particular reference to FIG. 15, a sheet of metal H is provided and an edge thereof is bent into a generally U-shaped profile as shown. In this regard, accordingly, the resulting product is a sheet of metal H having a first portion d₁ that is bent in a first direction (arrow 331) relative to a second portion d₂. Although not shown, the sheet of metal H is then formed into a tube. The resulting tube, thus, includes a relatively smooth, generally U-shaped outermost edge 12t.

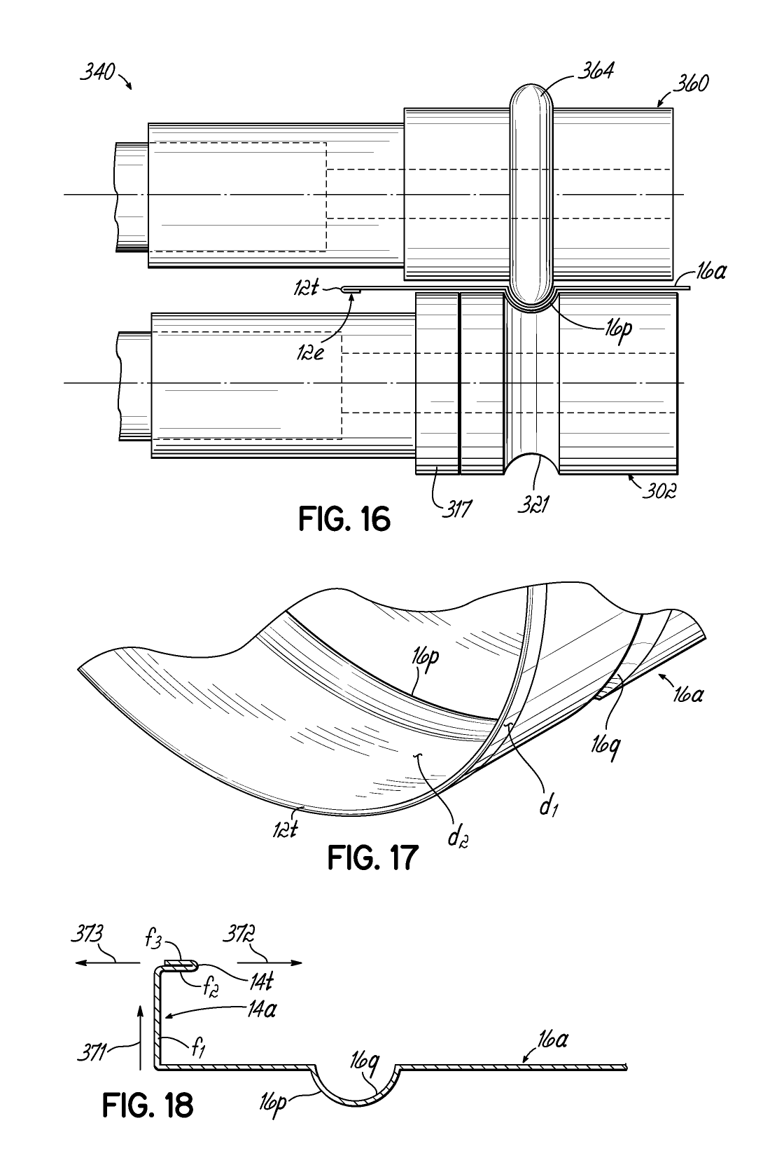

With particular reference to FIGS. 16-17, in which like reference numerals refer to like features of FIGS. 1-14, an exemplary system 340 is similar to systems 10, 110, 130, 133 and 310 (FIGS. 1-7 and 13-14), the description of which may be referred to for an understanding of system 340 as well. System 340 includes a third roller 360 that is selectively engageable with second roller 302 to form the protruding portion 16p of tube 16a. More specifically, tube 16a is engaged between second roller 302 and third roller 360, as shown. Third roller 360 includes a radially outwardly extending protrusion or bead 364 having the form of a ring of a generally convex profile and circumferentially disposed there about. Protrusion 364 is in registration with the annular recess 321 of the second roller 302. The second and third rollers 302, 360 are moved into engagement with one another such that their rotation results in rotation of tube 16a.

During this rotation, the third roller 360 is gradually moved into further engagement with second roller 302 such that the protrusion 364 is received, through the tube 16a, into annular recess 321. This movement, in turn, deforms the portion of tube 16a lying between the protrusion 364 and annular recess 321, thereby reshaping such portion into the annular protruding portion 16p of tube 16a, as shown in FIG. 17. The resulting tube 16a may then be processed as shown in FIGS. 13 and 14, to form the remainder of the flange 12a. It is contemplated that one or both of the second and third rollers 302, 360 may be movable relative to the other of the second and third rollers 302, 360. For example, and without limitation, the second roller 302 may be movable toward the third roller 360 while the third roller 360 is relatively static, or vice versa.

The methods described in the exemplary embodiments of FIGS. 13-17, accordingly, and with further reference to FIG. 18, contemplate, for example and without limitation, forming a flange 12a by bending a first portion f₁ thereof in a first direction (arrow 371) to thereby form a first segment of the flange 12a. The methods further contemplate bending a second portion f₂ relative to the first portion f₁ in a second direction (arrow 372) and bending a third portion f₃ relative to the second portion f₂ in a third direction (arrow 373). In the embodiment of FIG. 18, the second and third directions (arrows 372, 373) are generally parallel to one another, although this is intended to be merely exemplary rather than limiting.

In the embodiment of FIG. 18, moreover, the first and second directions (arrows 371, 372) are transverse to one another and more particularly generally orthogonal to one another. This relationship between the first and second directions is likewise intended to be exemplary rather than limiting. In the contemplated methods, moreover, bending of the third portion f₃ is effected prior to bending of the second portion f₂ relative to the first portion f₁, although this order of bending of the different portions is similarly intended to be exemplary rather than limiting.

The resulting exemplary tube 16a and flange 12a of FIG. 18 includes a relatively smooth outermost edge 12t of the flange 12a. Moreover, the generally U-shaped profile of the end 12e of flange 12a lends structural rigidity to the flange 12a. The exemplary tube 16a also includes an annular protruding portion 16p adjacent the flange 12a that lends structural rigidity to the end portion of tube 16a.

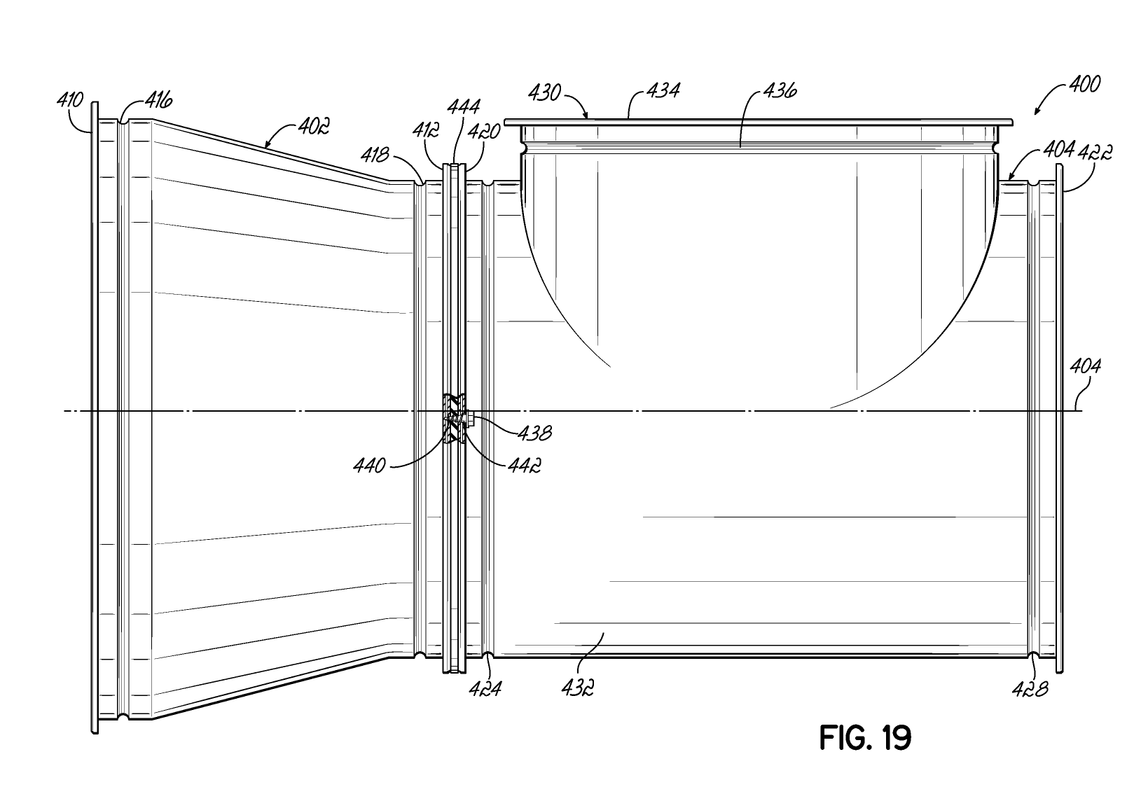

With reference to FIGS. 19, 20, 21A, 21B, 22A, 22B, 23A, 23B, and 24, different embodiments of air duct assemblies are illustrated and described. The formation of at least some of the components of these assemblies is facilitated by the flange-forming systems and methods described above.

With particular reference to FIG. 19, an air duct assembly 400 includes an air duct fitting 402 which could, for example be a spiral air duct fitting, coupled to a T-shaped tube fitting 404 extending generally along a longitudinal axis 404x. Air duct fitting 402 has a generally frustoconical profile to thereby define a reducer-type fitting and includes first and second flanges 410, 412 formed at opposite ends thereof. A pair of annular depressions or recesses 416, 418 are located respectively adjacent each of the flanges 410, 412 and are configured to receive respective gasket members, as described in further detail below.

The T-shaped tube fitting 404 likewise includes first and second flanges 420, 422 at opposite ends thereof and first and second annular depressions or recesses 424, 428 respectively adjacent each of the flanges 420, 422. A lateral tube end 430 extends generally transverse to axis 404x and extends from the body 432 of the tube fitting 404. Lateral tube end 430 includes a respective flange 434 and annular recess 436. Fittings 402 and 404 are coupled to one another through engagement of the respective flanges 412, 420, which are in confronting relationship with one another, via one or more fasteners such as metal screws 438 (only one shown) inserted through corresponding holes 440, 442 in the flanges 412, 420. A generally annular gasket member 444 is disposed between the flanges 412, 420 and prevents or restricts the travel of fluid from the exterior and into the interior of fittings 402 and 404. To this end, the metal screws 438 likewise penetrate through the thickness of the gasket member 444 to thereby secure the same relative to the flanges 412, 420.

Although not shown, a barrel clamp or similar structure may be placed over the confronting flanges 412, 420 to further restrict the travel of fluid into the interior portions of fittings 402, 404. The configuration of the barrel clamp may, for example, be similar to one or more of the clamp configurations shown in FIGS. 12A-12Q. Notably, the presence of the annular recesses 418, 424 respectively adjacent the flanges 412, 420 permits coupling of the fittings 402, 404 with redundant protection against the travel of fluid into the interior portions of fittings 402, 404. More specifically, the fittings 402, 404 may be coupled as described above with the gasket member 444 between the flanges 412, 420 and in addition through the clamp (not shown) disposed over the flanges, for example as shown in FIGS. 12A-12Q and with respective gasket members retained in each of the annular recesses 418, 424.

The fittings 402, 404 may be alternatively coupled without the gasket member 444 between the flanges 412, 420 and solely protect the interior portions of the fittings 402, 404 from fluids from the exterior. To this end, the gasket members (not shown) are retained in the annular recesses 418, 424 and the clamp (not shown) disposed over the gasket members and flanges 412, 420 to secure the flanges 412, 420 relative to one another.

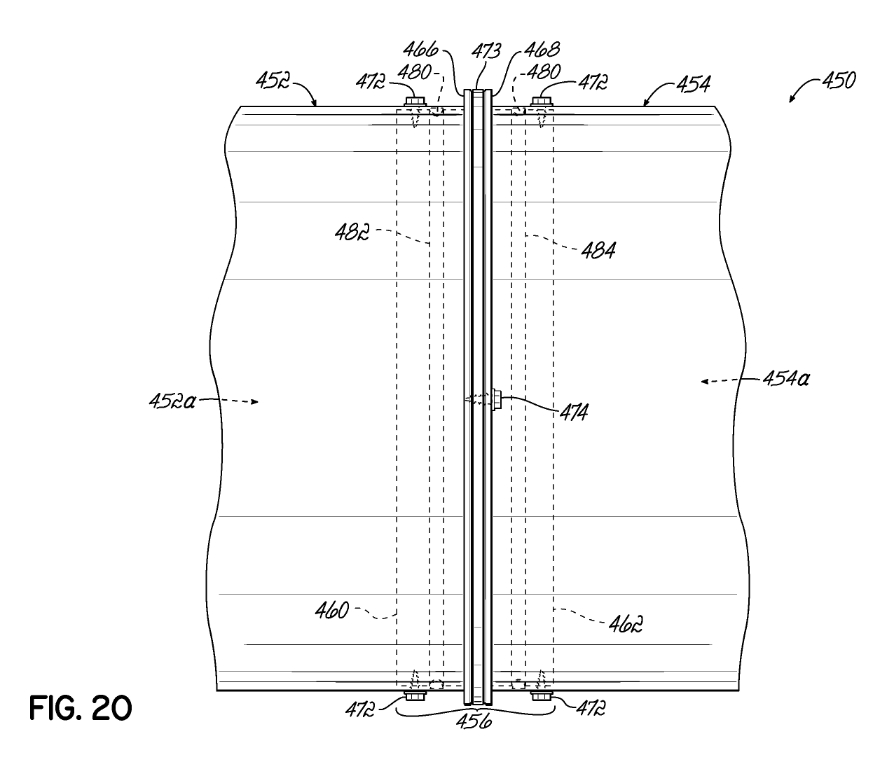

FIG. 20 further illustrates the above-discussed concept of redundant protection from liquid from the exterior. FIG. 20 shows an assembly 450 that includes first and second tubes 452, 454 joined together (i.e., coupled) through a tubular structure 456 partially disposed in the interior portions of the tubes 452, 454. Tube structure 456 includes respective first and second tubular body portions 460, 462 and respective flanges 466, 468 extending outwardly from the interior of the tubes 452, 454 and in confronting relationship with one another.

The tube structure 456 is secured relative to the first and second tubes 452, 454 through fasteners such as metal screws 472 extending through the tubes 452, 454 and through the tubular body portions 460, 462. A gasket member 473 is disposed between the confronting flanges 466, 468 through a fastener such as a metal screw 474 which also secures the flanges 466, 468 relative to one another.

With continued reference to FIG. 20, two gasket members 480 are each respectively retained in respective annular recesses 482, 484 of the tubular body portions 460, 462. In this regard, the gasket members 480 close the spaces between each of the tubular body portions 460, 462 and the corresponding tube 452, 454 associated therewith. In this regard, therefore, the gasket member 473 disposed between the flanges 473 presents a first line of defense against the travel of fluid into the interior portions 452a, 454a of the tubes 452, 454. The gasket members 480 present a second, redundant line of defense against the travel of fluid into the interior portions 452a, 454a.

Each of the gasket members 473, 480 is chosen for the particular application. One or both of these may, for example, have a round cross-section, a generally U-shaped cross section, or any other suitably chosen cross-section to provide the required type of protection (against fluid flow into the interior portions 452a, 454a) for the particular application.

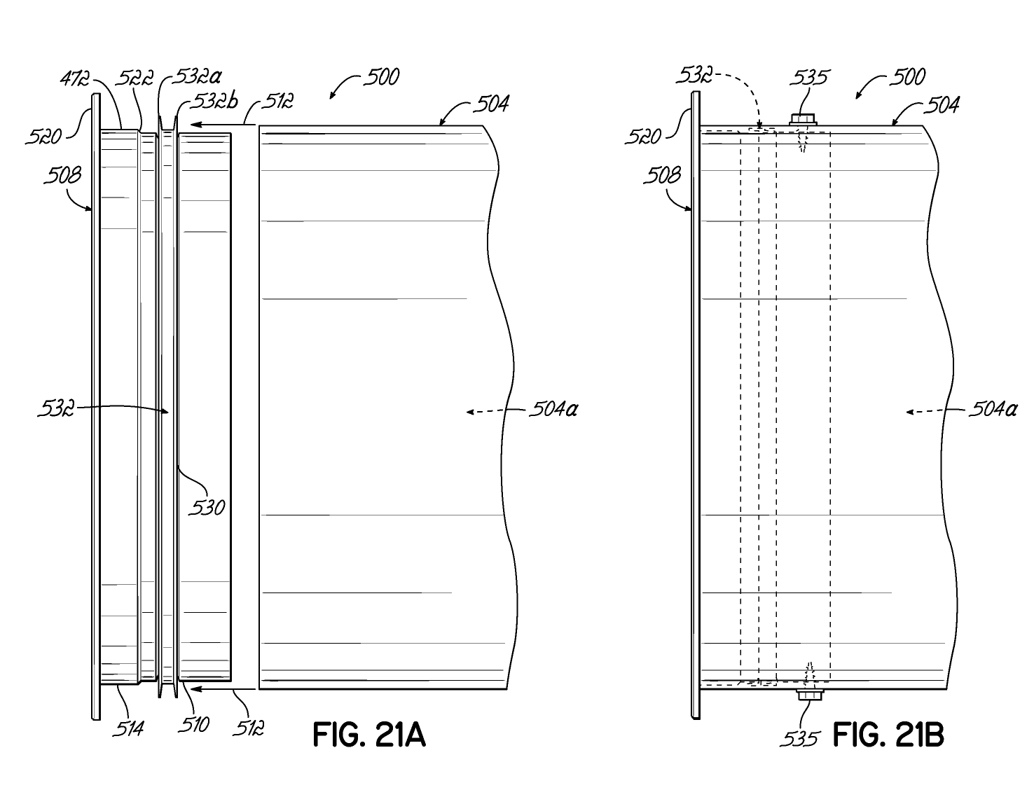

With reference to FIGS. 21A-21B, another embodiment of an air duct assembly 500 includes an air duct 504 coupled to a flange fitting 508. Air duct 504 may, for example, and without limitation, be a spiral air duct. Flange fitting 508 includes a first tubular body portion 510 having a diameter smaller than that of air duct 504 such that it may be slid into the interior portion 504a as suggested by the general direction of relative movement indicated by arrows 512. A second tubular body portion 514, generally concentric with the first tubular body portion 510 of the fitting 508 is larger and is adjacent a flange 520 that projects from the second body portion 514. The second body portion 514 may, for example, have a diameter similar to that of the air duct 504. An intermediate portion 522 of the fitting 508 connects the first and second body portions 510, 514 to provide a transition between the two dimensionally (e.g., in diameter) different body portions 510, 514.

The first body portion 510 includes an annular recess 530 similar to the annular recesses described above with respect to the other embodiments, and configured to receive and retain a gasket member 532. The exemplary gasket member 532 of this exemplary embodiment has a generally U-shaped cross-section although this is merely illustrative rather than limiting. As shown in FIG. 21B, the air duct 504 is coupled to the flange fitting 508 through a fastener such as metal screws 535. When the air duct 504 and the flange fitting 508 are coupled to one another, the gasket member 532 is compressed, with the two legs defining the U-shaped cross-section collapsing and thereby also providing redundant protection against the travel of fluid into the interior portion 504a of air duct 504. More specifically, each of the legs 532a, 532b of the gasket member 532 is collapsed and remains in engagement with the inner surface of the air duct 504 to jointly provide at least two barriers in the path of travel of fluid into the interior portion 504a.

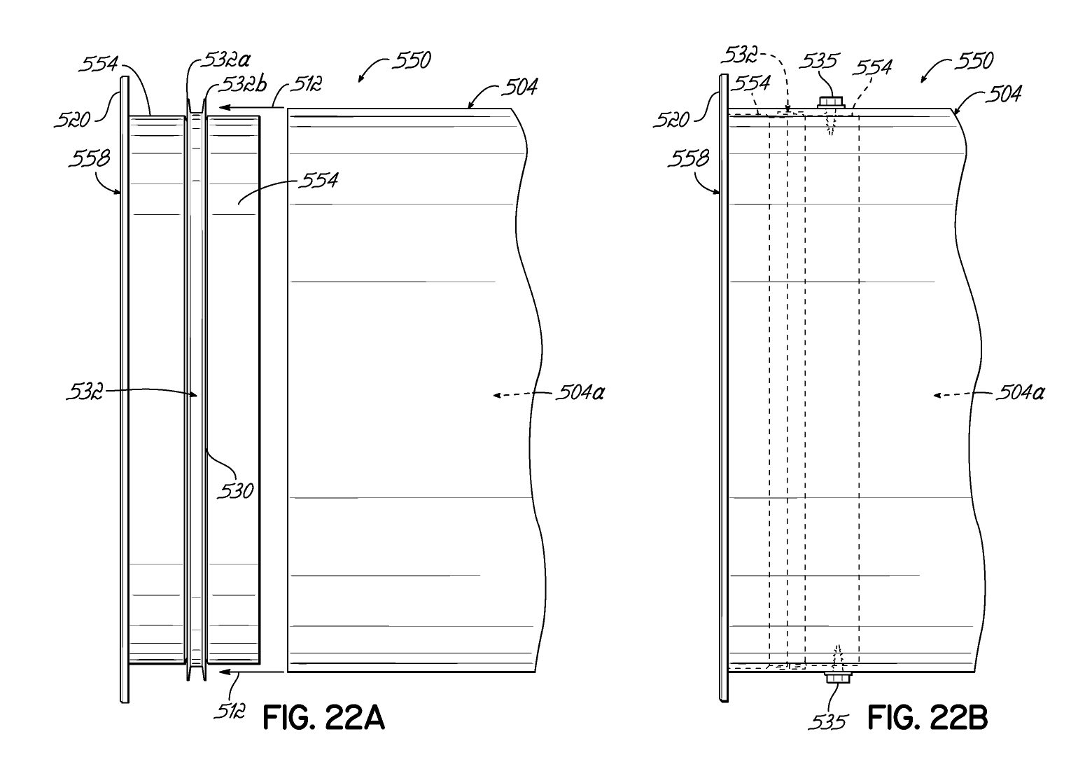

With reference to FIGS. 22A-22B, in which like reference numerals refer to like features in FIGS. 21A-21B, another embodiment of an air duct assembly 550 is very similar to air duct assembly 500 (FIGS. 21A-21B). Air duct assembly 550 does not include a flange fitting having first and second tubular body portions having different diameters but rather a flange fitting 558 having a pair of body portions 554 having substantially the same diameter. This diameter is smaller than the diameter of the air duct 504 such that the flange fitting 558 may be slid into the interior portion 504a as suggested by the general direction of relative movement indicated by arrows 512. Other functions and relationships between the different components of the air duct assembly 550 may be gathered from the description of similar components of the embodiment of FIGS. 21A-21B.

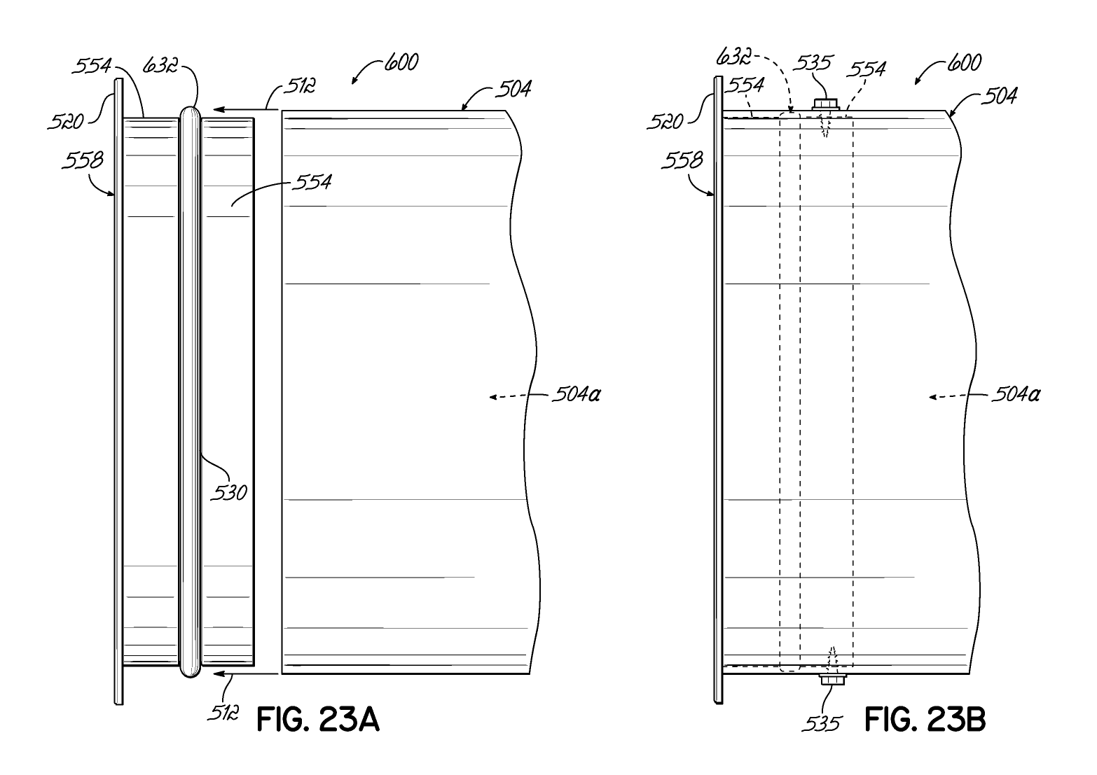

With reference to FIGS. 23A-23B, in which like reference numerals refer to like features of FIGS. 22A-22B, another embodiment of an air duct assembly 600 includes a gasket member 632 having a generally round cross-section. Other functions and relationships between the different components of the air duct assembly 600 may be gathered from the description of similar components of the embodiment of FIGS. 22A-22B. By way of contrast, the round cross-section of the gasket member 632 provides a contacting surface with the inner surface of the air duct 504 that is different from the two-point contact surface provided by the U-shaped gasket member 532 of the embodiments of FIGS, 21A-21B and 22A-22B.

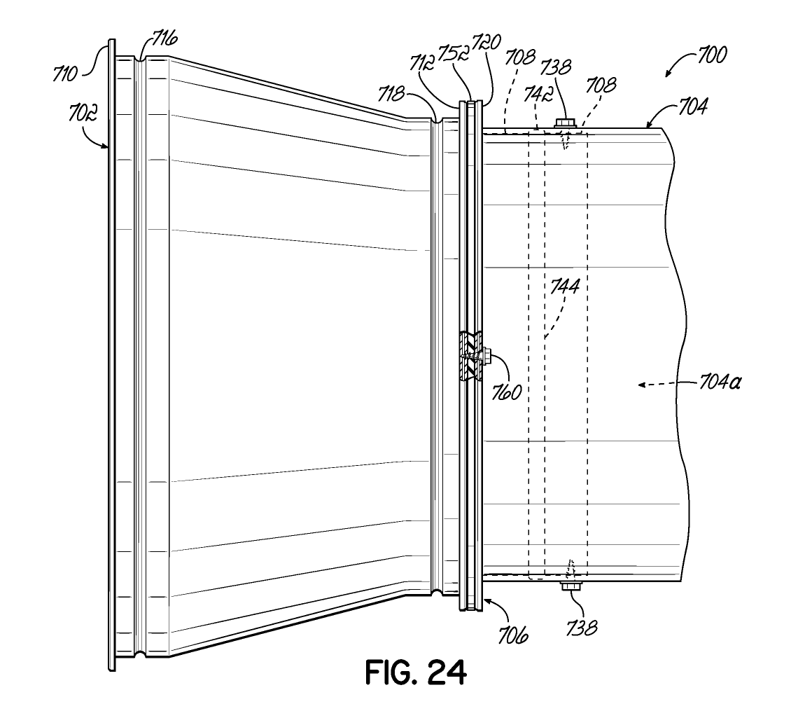

With reference to FIG. 24, another embodiment of an air duct assembly 700 includes an air duct fitting 702 which could, for example be a spiral air duct fitting, coupled to an air duct 704 through a flange fitting 706 that is partially disposed within the interior portion 704a of air duct 704. Air duct fitting 702 has a generally frustoconical profile to thereby define a reducer-type fitting and includes first and second flanges 710, 712 formed at opposite ends thereof. A pair of annular depressions or recesses 716, 718 are located respectively adjacent each of the flanges 710, 712 and are each configured to receive respective gasket members, as generally described above with respect to other similar embodiments.

The air duct 704 is a generally tubular structure and does not include a flange formed at the shown end thereof. In this regard, therefore, the flange fitting 706 provides a coupling of air duct 704 with the air duct fitting 702. To this end, flange fitting 706 includes a tubular body portion 708 that has a diameter smaller than the diameter of the air duct 704 such that the tubular body portion 708 may be slidingly received within the interior portion 704a of air duct 704. A flange 720 extends radially outwardly from the tubular body portion 708 and is disposed in confronting relationship with the flange 712 of the air duct fitting 702. Coupling between the flange fitting 706 and the air duct 704 is facilitated, in this embodiment, by one or more fasteners such as metal screws 738 inserted through air duct 704 and through the tubular body portion 708, as shown. A gasket member 742 is retained within an annular recess 744 of the flange fitting 706 that is adjacent the flange 720. A second gasket member 752 is disposed between the confronting flanges 712, 720 and is secured relative to these two flanges by a fastener such as a metal screw 760 in ways similar to the metal screw 438 described with reference to the embodiment of FIG. 19, above. Jointly, the gasket members 742 and 752 provide redundant protection from travel or flow of fluid from the exterior and into the interior portions 704a and 702a of the air duct 704 and air duct fitting 702, respectively.

Although not shown, a clamp may be applied over the flanges 712, 720 to further secure the coupling engagement between the second gasket member 752 relative to the flanges and to further secure air duct fitting 702 and flange fitting 706 relative to one another. The configuration of the clamp may, for example, take the form of one of the embodiments shown in FIGS. 12A-12Q. It should be readily appreciated that although certain embodiments and configurations of the invention are shown and described herein, the invention is not so limited. Moreover, any of the features and/or functions described above for any of the above embodiments may be combined with any other embodiments.

From the above disclosure of the general principles of the present invention and the preceding detailed description of exemplary embodiments, those skilled in the art will readily comprehend the various modifications to which this invention is susceptible. For example, while a spiral tube is depicted herein for illustrative purposes, other types of tubes are contemplated. Therefore, this invention is intended to be limited only by the scope of the following claims and equivalents thereof.

What is claimed is:

1. A system for forming a flange at an end of a tube comprising:
a collar configured to surround the tube;
a first roller engaging said collar;
a second roller configured to cooperate with said first roller to rotate said collar and the tube and including a depression configured to receive a radially inwardly protruding portion of the tube therein; and
a rotatable cam cooperating with said second roller and including a cam surface configured to bend the end of the tube to thereby form the flange.

2. The system of claim 1, wherein said depression in said second roller is configured to restrict axial movement of the tube relative to said collar.

3. The system of claim 1, wherein said depression includes an annular recess circumferentially disposed about said second roller.

4. The system of claim 1, wherein said depression has a generally rounded cross-sectional profile, said depression configured to receive a complementarily shaped protruding portion of the tube therein.

5. The system of claim 1, wherein said second roller includes an abutment surface in confronting relation with said rotatable cam for limiting axial displacement of said rotatable cam relative to the tube.

6. The system of claim 1, further comprising:
a third roller selectively engageable with said second roller and including a radially outwardly extending protrusion engageable with said depression for forming the radially inwardly protruding portion of the tube.

7. The system of claim 6, wherein said radially outwardly extending protrusion comprises a ring circumferentially disposed about said third roller.

8. A system for forming a flange at an end of a tube comprising:
a collar configured to surround the tube;
a first roller engaging said collar;
a second roller configured to cooperate with said first roller to rotate said collar and the tube and including an annular recess configured to receive a radially inwardly protruding portion of the tube therein;
a rotatable cam cooperating with said second roller and including a cam surface configured to bend the end of the tube to thereby form the flange; and
a third roller selectively engageable with said second roller and including a radially outwardly extending protrusion engageable with said annular recess for forming the radially inwardly protruding portion of the tube.

9. A method of forming a flange at an end of a tube, the method comprising:
engaging an outer surface of the tube to thereby rotate the tube;
rotating a first cam to advance a cam surface thereof against the end of the tube to thereby form the flange; and
forming a radially inwardly protruding portion in the tube generally adjacent the flange.

10. The method of claim 9, further comprising:
engaging the radially inwardly protruding portion to restrict movement of the tube relative to the first cam.

11. The method of claim 9, further comprising:
positively limiting axial displacement of the first cam relative to the tube.

12. The method of claim 9, further comprising:
bending a distal edge of the tube into a generally U-shaped profile.

13. The method of claim 9, further comprising:
engaging the tube between two complementarily-shaped structures to thereby form the radially inwardly protruding portion.

14. The method of claim 9, further comprising:
engaging the tube between a convex apparatus and a concave apparatus to thereby form the radially inwardly protruding portion.

15. The method of claim 9, further comprising:
forming the radially inwardly protruding portion prior to forming the flange.

16. The method of claim 12, further comprising:
bending the distal edge of the tube prior to forming the flange.

17. A method of forming a flange at an end of a tube, the method comprising:
bending a first portion of the tube in a first direction to thereby form a first segment of the flange;
bending a second portion of the tube relative to the first portion in a second direction to thereby form a second segment of the flange; and
bending a third portion of the tube relative to the second portion in a third direction to thereby form a third segment of the flange.

18. The method of claim 17, wherein the second and third directions are generally parallel to one another.

19. The method of claim 17, wherein the first and second directions are transverse to one another.

20. The method of claim 17, wherein the first and second directions are generally orthogonal to one another.

21. The method of claim 17, wherein bending the third portion relative to the second portion defines an outermost edge of the flange.

22. The method of claim 21, further comprising:
bending the third portion relative to the second portion prior to bending of the second portion relative to the first portion.

23. An air duct, comprising:
a first tubular body portion having an end;
a flange extending outwardly from said first tubular body portion at said end; and
an annular recess in said first tubular body portion for retaining a gasket therein.

24. The air duct of claim 23, wherein said first tubular body portion defines a metal spiral tube.

25. The air duct of claim 23, wherein said first tubular body portion is generally frustoconical in shape.

26. The air duct of claim 23, further comprising:
a tube end extending from said first tubular portion and oriented transverse to a longitudinal axis of said tubular portion.

27. The air duct of claim 23, further comprising:
a second tubular body portion generally concentric with said first tubular body portion and having a diameter different from that of said first tubular body portion.

28. An air duct assembly comprising:
a first tubular structure;
a second tubular structure coupled to said first tubular structure and having a first flange at an end thereof in confronting relationship with said first tubular structure and an annular recess adjacent said flange; and
a gasket member retained in said annular recess and disposed between said first and second tubular structures for restricting the travel of fluid into an interior portion of said second tubular structure.

29. The air duct assembly of claim 28, further comprising:
a second gasket member positioned against said flange for further restricting travel of fluid into said interior portion.

30. The air duct assembly of claim 28, further comprising:
a second flange extending from said first tubular structure and in confronting relationship with said first flange
